(19) United States
(12) Patent Application Publication
(10) Pub. No.: US 2017/0255118 A1
(43) Pub. Date: Sep. 7, 2017

(54) BRILLIANT TONER, ELECTROSTATIC CHARGE IMAGE DEVELOPER, AND TONER CARTRIDGE

(71) Applicant: FUJI XEROX CO., LTD., Tokyo (JP)

(72) Inventors: Masaru TAKAHASHI, Kanagawa (JP); Satomi HARA, Kanagawa (JP); Sakiko HIRAI, Kanagawa (JP); Atsushi SUGAWARA, Kanagawa (JP)

(73) Assignee: FUJI XEROX CO., LTD., Tokyo (JP)

(21) Appl. No.: 15/216,239

(22) Filed: Jul. 21, 2016

(30) Foreign Application Priority Data
Mar. 3, 2016 (JP) 2016-041028

(51) Int. Cl. G03G 9/00

(52) U.S. Cl. CPC G03G 9/0926; G03G 9/0902; G03G 9/0819; G03G 9/0827; G03G 9/08755; G03G 9/107; G03G 15/0865

(57) ABSTRACT

A brilliant toner includes toner particles that contain a binder resin and a brilliant pigment, wherein a water surface diffusion area, which is defined by JIS K5906:2009, of the brilliant pigment is from 5 m²/g to 20 m²/g and an average longitudinal length of the brilliant pigment is from 0.5 μm to 10 μm.

### CROSS-REFERENCE TO RELATED APPLICATIONS

This application is based on and claims priority under 35 USC 119 from Japanese Patent Application No. 2016-041028 filed Mar. 3, 2016.

### BACKGROUND

1. Technical Field

The present invention relates to a brilliant toner, an electrostatic charge image developer, and a toner cartridge.

2. Related Art

In recent years, usage of a brilliant toner containing a brilliant pigment for the purpose of forming an image with gloss such as metallic luster is examined.

### SUMMARY

According to an aspect of the invention, there is provided a brilliant toner including:

toner particles that contain a binder resin and a brilliant pigment,

wherein a water surface diffusion area, which is defined by JIS K5906:2009, of the brilliant pigment is from 5 m²/g to 20 m²/g, and

an average longitudinal length of the brilliant pigment is from 0.5 μm to 10 μm.

### BRIEF DESCRIPTION OF THE DRAWINGS

Exemplary embodiments of the present invention will be described in detail based on the following figures, wherein:

FIG. 1 is a sectional view schematically illustrating an example of toner particles according to an exemplary embodiment;

FIG. 2 is a configuration diagram schematically illustrating an example of an image forming apparatus according to the exemplary embodiment; and

FIG. 3 is a configuration diagram schematically illustrating an example of a process cartridge according to an exemplary embodiment.

### DETAILED DESCRIPTION

Hereinafter, detailed description will be given of a brilliant toner, an electrostatic charge image developer, a toner cartridge, a process cartridge, an image forming apparatus, and an image forming method according to an exemplary embodiment of the invention.

### Brilliant Toner

A brilliant toner according to an exemplary embodiment (hereinafter, referred to as a “toner” in some cases) is a toner that includes toner particles containing a binder resin and a brilliant pigment, in which a water surface diffusion area, which is defined by JIS K5906:2009, of the brilliant pigment (hereinafter, referred to as a “water surface diffusion area” in some cases) is from 5 m²/g to 20 m²/g and an average longitudinal length is from 0.5 μm to 10 μm.

According to the toner of the exemplary embodiment, deterioration of granularity in a case of forming gradation images is prevented. The reason is inferred as follows though not clear.

In a case of forming gradation images by using a brilliant toner, and in particular, when a large amount of gradation images are formed at a high speed in a high-temperature and high-moisture environment, dot disturbance in the gradation images may separately cause a portion where the brilliant pigment is present and a portion where the brilliant pigment is not present in the gradation images. The dot disturbance in the gradation images are visually recognized as deterioration of granularity in the gradation images. Since the brilliant toner in the related art has a large particle size and an area of covering a recording medium, such as paper, per a unit weight of the toner is small, clearance that is not covered with the brilliant pigment tends to occur in the gradation images. This is considered to be a reason that the dot disturbance tends to occur in the gradation images. Since the brilliant toner typically has a large particle diameter, the portion where the brilliant pigment is not present outstandingly appears.

According to the toner of the exemplary embodiment, a brilliant pigment with a water surface diffusion area, which is defined by JIS K5906:2009, from 5 m²/g to 20 m²/g is used as the brilliant pigment. Therefore, an area of covering the recording medium per a unit weight of the toner is large. Therefore, since the clearance that is not covered with the brilliant pigment tends not to occur in the gradation images during fixation of the brilliant toner even if the dots are disturbed in the gradation images when the brilliant toner is transferred to the surface of the recording medium, smooth gradation images tend to be obtained. Therefore, the deterioration of granularity in the case of forming the gradation images is considered to be prevented.

In the exemplary embodiment, “granularity” is a scale indicating image defect, and the image defect decreases as the granularity is enhanced.

In the toner according to the exemplary embodiment, a toluene insoluble portion other than inorganic matters is preferably from 0.1% by weight to 50% by weight, more preferably from 2% by weight to 30% by weight, and further preferably from 3% by weight to 10% by weight with respect to the entire toner.

The toluene insoluble portion is adjusted, for example, by 1) a method of forming a crosslinked structure or a branched structure by adding a crosslinking agent to a polymer component having a reactive functional group at a terminal, 2) a method of forming a crosslinked structure or a branched structure by adding a polyvalent metal ion to a polymer component having an ionic functional group at a terminal, or 3) a method of extending or forming branches of a resin chain length by treating with isocyanate or the like.

Here, the toluene insoluble portion is constituents except for inorganic matters in toner constituents which are insoluble in toluene. However, in a case in which a release agent is contained in the toner particles as well as the brilliant pigment and the binder resin, the toluene insoluble portion represents a toluene insoluble portion other than the inorganic matters and the release agent. That is, the toluene insoluble portion represents an insoluble portion that contains binder resin components which are insoluble in toluene (high-molecular weight components of the binder resin, in particular) as main components (equal to or greater than 90% by weight with respect to the entirety, for example). A non-brilliant pigment, an external additive, and the like as well as the brilliant pigment correspond to the inorganic matters.

The toluene insoluble portion is a value measured by the following method.

First, the toner as a target of measurement is embedded by using a bisphenol A-type liquid epoxy resin and a curing agent, and a sample to be cut is then created. Then, a cutting machine using a diamond knife such as UltracutUCT (manufactured by Leica) is used to cut the sample into pieces at −100° C.

A section of the sample cut into pieces is observed by a scanning electron microscope with an energy dispersed-type X-ray analyzer (SEM-EDX), and constituent elements of inorganic matters (the flake-shaped brilliant pigment (observed in a needle shape in the section) and external additive in a case in which the external additive is externally added to the toner particles) that are present in the toner are identified by the energy dispersed-type X-ray analyzer (EDX). Then, the amount (% by weight) of the inorganic matters is determined by a fluorescent X-ray analyzer.

Here, an electron microscope “S-4100” manufactured by Hitachi, Ltd. with an energy dispersed-type X-ray analyzer “EMAX model 6923H” manufactured by Horiba, Ltd. is used as the scanning electron microscope with the energy dispersed-type X-ray analyzer, and an accelerating voltage is set to 20 kV as a measurement condition. In contrast, a “fluorescent X-ray analyzer XRF-1500” manufactured by Shimadzu Corporation is used as a fluorescent X-ray analyzer, and a tube voltage is set to 40 kV, a tube current is set to 90 mA, and a measurement time is set to 5 minutes as the measurement conditions.

In contrast, 1 g of weighed toner is put into a cylindrical filter paper made of weighed glass fiber and is attached to an extraction tube of a heating-type Soxhlet extractor. Then, toluene is poured into a flask and is heated at 110° C. by using a mantle heater. In addition, a periphery of the extraction tube is heated at 125° C. by using a heater attached to the extraction tube. Extraction is performed at such a reflux speed that one extraction cycle is performed within a range from 4 minutes to 5 minutes. After the extraction for 10 hours, the cylindrical filter paper and toner residual are extracted, dried, and weighed.

Then, the toner residual amount (% by weight) is calculated based on an equation: toner residual amount (% by weight)=[(amount of cylindrical filter paper+toner residual amount) (g)−amount of cylindrical filter paper (g)]/weight of toner (g)×100. The toner residual includes inorganic matters such as the brilliant pigment and the external additive and a toluene insoluble portion. In a case in which the toner particles contain a release agent, the release agent corresponds to toluene soluble portion since extraction by heating is performed.

Then, the toluene insoluble portion (% by weight) is calculated from “the amount (% by weight) of the inorganic matters (the brilliant pigment and an external additive in a case in which the external additive is externally added) by quantification by the fluorescent X-ray analyzer and “the toner residual amount (% by weight)” extracted by the heating Soxhlet extractor. That is, the toluene insoluble portion (% by weight) is calculated from an equation “toluene insoluble portion (% by weight)”=“toner residual amount (% by weight)”−“amount of inorganic matters (% by weight)”.

In the toner according to the exemplary embodiment, “brilliance” means gloss such as metallic luster when an image formed by the brilliant toner is viewed.

Specifically, the toner according to the exemplary embodiment preferably has a ratio (X/Y) from 2 to 100 between reflectance X at a light receiving angle of +30° and reflectance Y at a light receiving angle of −30° measured in a case in which a solid image is formed and the image is irradiated with incident light with an incident angle of −45° by a variable-angle photometer.

The ratio (X/Y) of equal to or greater than 2 represents that reflection on the opposite side (positive angle side) to the incident side is greater than reflection on the incident side (minus angle side) on which the incident light is incident, that is, scattered reflection of the incident light is prevented. In a case in which scattered reflection of incident light in various directions occurs, the reflected light is observed to have a dull-hued color in visual recognition. Therefore, there is a case in which luster may not be observed in the visual recognition of the reflected light and brilliance deteriorates if the ratio (X/Y) is less than 2.

In contrast, if the ratio (X/Y) exceeds 100, there is a case in which a viewing angle in which the reflected light may be visually recognized becomes excessively narrow and a blackish color is observed depending on a viewing angle due to a large regular reflected light component.

The ratio (X/Y) is preferably from 4 to 50, more preferably from 6 to 20, and particularly preferably from 8 to 15 in terms of brilliance and toner manufacturability. Measurement of ratio (X/Y) by variable-angle photometer

Here, description will be given first of the incident angle and the light receiving angle. In the measurement by the variable-angle photometer in the exemplary embodiment, the incident angle is set to −45° since high measurement sensitivity is achieved with respect to images with glossiness in a wide range.

The light receiving angle is set to −30° and +30 since the highest measurement sensitivity is achieved in evaluation of images with glossy feeling and images with no glossy feeling.

Next, description will be given of a method of measuring the ratio (X/Y).

A stereoscopic variable-angle colorimeter GC5000L manufactured by Nippon Denshoku Industries Co., Ltd. is used as a varied-angle photometer to cause incident light at an incident angle of −45° with respect to an image as a measurement target (brilliant image) to be incident on the image, and the reflectance X at the light receiving angle of +30° and the reflectance Y at the light receiving angle of −30° are measured. The reflectance X and the reflectance Y are measured from light with wavelengths in a range from 400 nm to 700 nm at an interval of 20 nm, and average values of the reflectance at the respective wavelengths are obtained. The ratio (X/Y) is calculated from these measurement results.

The toner according to the exemplary embodiment preferably satisfies the following requirements (1) and (2) from a viewpoint of satisfying the ratio (X/Y).

(1) An average equivalent circle diameter D is greater than an average maximum thickness C of the toner particles.

(2) A rate of brilliant pigment with angles in a range from −30 to +30° between a longitudinal axis direction in sections of the toner particles in a thickness direction and a longitudinal axis direction of the brilliant pigment in observation thereof is equal to or greater than 60% of the entire brilliant pigment observed.

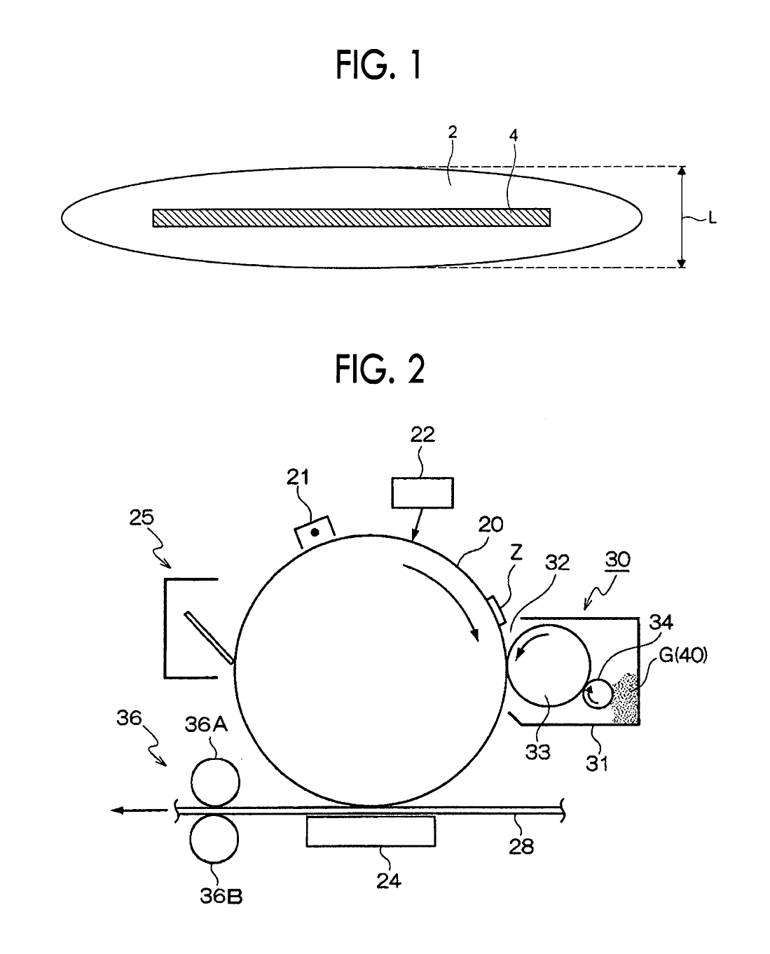

It is considered that if the toner particles have a flake shape in which the equivalent circle diameter is longer than the thickness (see FIG. 1), then the flake surface side of the flake-shaped toner particles are aligned so as to face the surface of the recording medium in a fixation process for forming an image due to pressure during the fixation. In FIG. 1, 2 represents the toner particles, 4 represents the brilliant pigment, and L represents the thickness of the toner particles.

Therefore, it is considered that a side of the maximum area surface of the brilliant pigment, which satisfies the requirement (2) “angles are in a range from −30 to +300 between a longitudinal axis direction in sections of the toner and a longitudinal axis direction of the brilliant pigment”, in the flake-shaped (flaky) brilliant pigment contained in the toner particles is aligned so as to face the surface of the recording medium. It is considered that the above range of ratio (X/Y) is achieved since the rate of the brilliant pigment reflected in a scattered manner is prevented with respect to the incident light in a case of causing light to be incident on the thus formed image.

Hereinafter, detailed description will be given of the toner according to the exemplary embodiment.

The toner according to the exemplary embodiment includes toner particles that contain at least a binder resin and a brilliant pigment. The toner particles according to the exemplary embodiment may contain other components as needed.

The toner according to the exemplary embodiment may include toner particles containing a brilliant pigment and a binder resin and an external additive that is externally added to the toner particles.

### Toner Particles

The toner particles contain the binder resin and the brilliant pigment. The toner particles may contain other additives such as a release agent as needed.

Binder resin Examples of the binder resin include a vinyl resin such as a homopolymer of a monomer such as styrenes (such as styrene, parachlorostyrene, or α-methylstyrene), (meth) acrylic acid esters (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, or 2-ethylhexyl methacrylate), ethylenic unsaturated nitriles (such as acrylonitrile, or methacrylonitrile), vinyl ethers (such as vinyl methyl ether, or vinyl isobutyl ether), vinyl ketones (vinyl methyl ketone, vinyl ethyl ketone, or vinyl isopropenyl ketone), olefins (such as ethylene, propylene, or butadiene) or a copolymer of two or more kinds of the monomers.

Examples of the binder resin also include a non-vinyl resin such as epoxy resin, polyester resin, polyurethane resin, polyamide resin, cellulose resin, polyether resin, or modified rosin, a mixture of such a non-vinyl resin and the vinyl resin, and graft polymer obtained by polymerizing a vinyl monomer in copresence of the non-vinyl monomer.

One kind or two or more kinds of such binder resins may be used alone or in combination.

Polyester resin is preferably used as the binder resin.

Examples of polyester resin include known polyester resin.

Examples of polyester resin include condensation polymer of polyvalent carboxylic acid and polyvalent alcohol. A commercially available polyester resin or synthesized polyester resin may be used.

Examples of polyvalent carboxylic acid include aliphatic dicarboxylic acid (such as oxalic acid, malonic acid, maleic acid, fumaric acid, citraconic acid, itaconic acid, glutaconic acid, succinic acid, alkenyl succinate, adipic acid, or sebacic acid), alicyclic dicarboxylic acid (such as cyclohexane dicarboxylic acid), aromatic dicarboxylic acid (such as terephthalic acid, isophthalic acid, phthalic acid, or naphthalenedicarboxylic acid), anyhydride thereof, or lower alkyl ester (containing from 1 to 5 carbon atoms, for example) thereof. Among the examples, aromatic dicarboxylic acid, for example, is preferably used as polyvalent carboxylic acid.

As polyvalent carboxylic acid, trivalent or higher carboxylic acid with a crosslinked structure or a branched structure may be used with dicarboxylic acid in combination. Examples of trivalent or higher carboxylic acid include trimellitic acid, pyromellitic acid, anhydride thereof, or lower alkyl ester (containing from 1 to 5 carbon atoms, for example) thereof.

One kind or two or more kinds of polyvalent carboxylic acid may be used alone or in combination.

Examples of polyvalent alcohol include aliphatic diol (such as ethylene glycol, diethylene glycol, triethylene glycol, propylene glycol, butanediol, hexanediol, or neopentyl glycol), alicyclic diol (such as cyclohexanediol, cyclohexanedimethanol, hydrogenated bisphenol A), and aromatic diol (such as ethylene oxide adduct of bisphenol A or propylene oxide adduct of bisphenol A). Among the examples, aromatic diol, alicyclic diol are preferably used, and aromatic diol is more preferably used as polyvalent alcohol.

As polyvalent alcohol, trivalent or higher polyvalent alcohol with a crosslinked structure or a branched structure may be used with diol in combination. Examples of trivalent or higher polyvalent alcohol include glycerine, trimethylol propane, and pentaerythritol.

One kind or two or more kinds of polyvalent alcohol may be used alone or in combination.

The glass transition temperature (Tg) of polyester resin is preferably from 50° C. to 80° C., and more preferably from 50° C. to 65° C.

The glass transition temperature is determined by a DSC curve obtained by a differential scanning calorimetry (DSC).

More specifically, the glass transition temperature is determined based on “Extrapolation glass transition onset temperature” described in how to determine glass transition temperature in JIS K 7121-1987 “Method of measuring plastic transition temperature”.

The weight average molecular weight (Mw) of polyester resin is preferably from 5,000 to 1,000,000, and more preferably from 7,000 to 500,000.

The number average molecular weight (Mn) of polyester resin is preferably from 2,000 to 100,000.

The molecular weight distribution Mw/Mn of polyester resin is preferably from 1.5 to 100, and more preferably from 2 to 60.

The weight average molecular weight and the number average molecular weight are measured by gel permeation chromatography (GPC). The molecular weight measurement by the GPC is performed by using GPC•HLC-8120GPC manufactured by Tosoh Corporation as a measurement apparatus, a column TSKgel SuperHM-M (15 cm) manufactured by Tosoh Corporation, and THF solvent. The weight average molecular weight and the number average molecular weight are calculated by using a molecular weight calibration curve created by a mono-dispersed polystyrene standard sample from the measurement result.

The polyester resin is obtained by a known manufacturing method. Specifically, the polyester resin is obtained by a method of setting a polymerization temperature to be from 180° C. to 230° C., for example, reducing a pressure in a reaction system as needed, and causing a reaction while removing water and alcohol that are generated during condensation.

In a case in which monomer of the raw materials are not dissolved or blended at the reaction temperature, a solvent with a high boiling temperature may be added as a solubilizer to promote the dissolution. In such a case, the polycondensation reaction is performed while evaporating the solubilizer. In a case in which monomer with low compatibility is present in the copolymerization reaction, it is preferable to condense the monomer with low compatibility and acid or alcohol to be polycondensed with the monomer in advance and then cause polycondensation with main constituents.

Here, examples of polyester resin other than the non-modified polyester resin include modified polyester resin. Modified polyester resin is polyester resin in which a linking group other than ester linking is present or polyester resin in which a different resin component from the polyester resin component is bonded by covalent bond or ion bond. Examples of modified polyester include resin with a terminal modified by causing a reaction between a polyester resin having a terminal into which a functional group, such as isocyanate group, which reacts with an acid group or a hydroxyl group, with an active hydrogen compound.

Urea-modified polyester resin is particularly preferable as the modified polyester resin. Inclusion of urea-modified polyester resin as the binder resin facilitates prevention of occurrence of damage in the fixing member due to the brilliant pigment. This is considered to be because urea-modified polyester has appropriate hydrophilicity and is arranged in the toner particles so as to surround the edge portion of the brilliant pigment as the toluene insoluble portion. On this point, the content of the urea-modified polyester resin is preferably from 10% by weight to 30% by weight, and more preferably from 15% by weight to 25% by weight with respect to the entire binder resin.

As the urea-modified polyester resin, urea-modified polyester resin obtained by a reaction (at least one of a crosslinking reaction and an elongation reaction) between polyester resin (polyester prepolymer) having isocyanate groups and an amine compound. The urea-modified polyester may contain urethane bond with urea bond.

Polyester prepolymer having isocyanate groups is polyester that is polycondensate of polyvalent carboxylic acid and polyvalent alcohol, and examples thereof include prepolymer obtained by causing a reaction between polyester with active hydrogen and a polyvalent isocyanate compound.

Examples of the group with active hydrogen included in polyester includes a hydroxyl group (alcoholic hydroxyl group and a phenolic hydroxyl group), an amino group, a carboxyl group, and a mercapto group, and an alcoholic hydroxyl group is preferably used.

Examples of polyvalent carboxylic acid and polyvalent alcohol in polyester prepolymer having isocyanate groups include similar compounds as polyvalent carboxylic acid and polyvalent alcohol described in relation to the polyester resin.

Examples of the polyvalent isocyanate compound include: aliphatic polyisocyanate (such as tetramethylene diisocyanate, hexamethylene diisocyanate, or 2,6-diisocyanatemethylcaproate); alicyclic polyisocyanate (such as isophoronediisocyanate, cyclohexylmethanediisocyanate), aromatic diisocyanate (tolylene diisocyanate or diphenylmethane diisocyanate); aromatic-aliphatic diisocyanate (α,α,α′,α′-tetramethyl xylylene diisocyanate); isocyanurates; and one obtained by blocking the above polyisocyanate with a blocking agent such as a phenol derivative, oxime, or caprolactam.

For the polyvalent isocyanate compound, one or two or more kinds of blocking agent may be used alone or in combination.

As for a ratio of the polyvalent isocyanate compound, an equivalent ratio [NCO]/[OH] between an isocyanate group [NCO] and a hydroxyl group [OH] in polyester prepolymer having an hydroxyl group is preferably from 1/1 to 5/1, more preferably from 1.2/1 to 4/1, and further preferably from 1.5/1 to 2.5/1. If [NCO]/[OH] is set to be from 1/1 to 5/1, tendency that the toluene insoluble portion is within the above range increases, and occurrence of damage in the fixing member due to the brilliant pigment tends to be prevented. If [NCO]/[OH] is set to be equal to or less than 5, deterioration of the low-temperature fixing property tends to be prevented.

In polyester prepolymer having isocyanate groups, the content of a component derived from a polyvalent isocyanate compound is preferably from 0.5% by weight to 40% by weight, more preferably from 1% by weight to 30% by weight, and further preferably from 2% by weight to 20% by weight with respect to the entire polyester prepolymer having isocyanate group. If the content of the component derived from polyvalent isocyanate is set to be from 0.5% by weight to 40% by weight, the tendency that the toluene insoluble portion is within the above range increases, and occurrence of damage in the fixing member due to the brilliant pigment tends to be prevented. If the content of the component derived from polyvalent isocyanate is set to be equal to or less than 40% by weight, deterioration of the low-temperature fixing property tends to be prevented.

The number of isocyanate groups contained in one molecule of the polyester prepolymer having isocyanate groups is preferably equal to or greater than 1 on average, more preferably from 1.5 to 3 on average, and further preferably from 1.8 to 2.5 on average. If the number of isocyanate groups per a molecule is set to be equal to or greater than 1, the molecular weight of the urea-modified polyester resin after the reaction increases, the tendency that the toluene insoluble portion is within the above range increases, and occurrence of the damage in the fixing member due to the brilliant pigment tends to be prevented.

Examples of the amine compound to be reacted with polyester prepolymer having isocyanate groups include diamine, trivalent or higher polyamine, amino alcohol, amino mercaptan, amino acid, and a compound obtained by blocking an amino group thereof.

Examples of diamine include aromatic diamine (phenylenediamine, diethyltoluenediamine, or 4,4′-diaminodphenylmethane); alicyclic diamine (such as 4,4-diamino-3,3′-dimethyldicyclohexylmethane, diaminecyclohexane, or isophoronediamine); and aliphatic diamine (such as ethylenediamine, tetramethylenediamine, or hexamethylenediamine).

Examples of trivalent or higher polyamine include diethylenetriamine and triethylenetetramine.

Examples of amino alcohol include ethanolamine and hydroxyethylaniline.

Examples of amino mercaptan include aminoethylmercaptan and aminopropylmercaptan.

Examples of amino acid include aminopropionic acid and aminocaproic acid.

Examples of the compound obtained by blocking an amino group thereof include a ketimine compound obtained from an amine compound such as diamine, trivalent or higher polyamine, amino alcohol, amino mercaptan, or amino acid and a ketone compound (such as acetone, methylethylketone, or methylisobutylketone) and an oxazoline compound.

Among these amine compounds, a ketimine compound is preferably used.

One kind or two or more kinds of the amine compounds may be used alone or in combination.

The urea-modified polyester resin may be resin with a molecular weight adjusted after a reaction by adjusting the reaction between the polyester resin having isocyanate groups (polyester prepolymer) and the amine compound (at least one of a crosslinking reaction and an elongation reaction) with a terminator (hereinafter, also referred to as a “crosslinking/elongation reaction terminator”) for stopping at least one of the crosslinking reaction and the elongation reaction.

Examples of the crosslinking/elongation reaction terminator include monoamine (such as diethylamine, dibutylamine, butylamine, or laurylamine) and a substance (ketimine compound) obtained by blocking monoamine.

As for a ratio of the amine compound, an equivalent ratio [NCO]/[NHx] of isocyanate groups [NCO] in polyester prepolymer having isocyanate groups and amino groups [NHx] in amines is preferably from 1/2 to 2/1, more preferably from 1/1.5 to 1.5/1, and further preferably from 1/1.2 to 1.2/1. If [NCO]/[NHx] is set within the above range, the molecular weight of the urea-modified polyester resin after the reaction increases, the tendency that the toluene insoluble portion is within the above range increases, and occurrence of damage in the fixing member due to the brilliant pigment tends to be prevented.

The glass transition temperature of the urea-modified polyester resin is preferably from 40° C. to 65° C., and further preferably from 45° C. to 60° C. The number average molecular weight is preferably from 2,500 to 50,000, and further preferably from 2,500 to 30,000. The weight average molecular weight is from 10,000 to 500,000, and further preferably from 30,000 to 100,000.

The content of the binder resin is preferably from 40% by weight to 95% by weight, more preferably from 50% by weight to 90% by weight, and further preferably from 60% by weight to 85% by weight with respect to the entire toner particles, for example.

Brilliant Pigment

As the brilliant pigment used in the exemplary embodiment, any pigment that has a water surface diffusion area, which is defined by JIS K5906:2009, from 5 m²/g to 20 m²/g and an average longitudinal length from 0.5 μm to 10 μm may be used without particular limitation.

If the water surface diffusion area of the brilliant pigment is less than 5 m²/g, the area covering a recording medium, such as paper, per a unit weight of the toner is small.

Therefore, granularity in the case of forming gradation images may be degraded. In contrast, if the water surface diffusion area is greater than 20 m²/g, orientation of the pigment may be disturbed, and granularity in the case of forming the gradation images may be degraded. The brilliant pigment used in the exemplary embodiment preferably has a water surface diffusion area from 6 m²/g to 15 m²/g, and more preferably has a water surface diffusion area from 7 m²/g to 10 m²/g.

If the average longitudinal length of the brilliant pigment is less than 0.5 m, orientation of the pigment may be disturbed, and the granularity in the case of forming the gradation images may be degraded. In contrast, if the average longitudinal length is greater than 10 μm, luminance of each brilliant pigment may increase, and the granularity may be degraded. The average longitudinal length of the brilliant pigment used in the exemplary embodiment is preferably equal to or greater than 0.5 μm and less than 5 μm, and more preferably from 1 μm to 4 μm.

The ratio (Lp/Dt) between an average longitudinal length (Lp) of the brilliant pigment and a volume average particle diameter (Dt) of the brilliant toner is preferably from 0.017 to 1.000.

Examples of the brilliant pigment used in the exemplary embodiment include a pigment obtained by flaking and pulverizing metal or a metal compound layer from a sheet base material at an interface between the metal or the metal compound layer of a composite pigment technical product with a structure, in which the resin layer for flaking and the metal or the metal compound layer are laminated in order on the sheet base material, for example, and the resin layer for flaking at a boundary.

The metal or the metal compound used in the metal or the metal compound layer of the composite pigment technical product for preparing the brilliant pigment used in the exemplary embodiment are not particularly limited as long as the metal or the metal compound has a function of exhibiting metallic luster, for example. However, aluminum, silver, gold, nickel, chromium, tin, zinc, indium, titanium, copper, or the like is used, and at least one kind of these single metals, metal compounds, alloys thereof, and mixtures thereof is used.

Among these examples, the brilliant pigment used in the exemplary embodiment is preferably a metal pigment containing the single metal, and is more preferably an aluminum pigment.

The metal or the metal compound layer is preferably formed by vacuum deposition, ion plating, or a sputtering method. The thickness of the metal or the metal compound layer is not particularly limited and is preferably in a range from 30 nm to 100 nm. If the thickness is equal to or greater than 30 nm, a reflecting property and a brilliance of the brilliant pigment are enhanced. If the thickness is equal to or less than 100 nm, an increase in apparent specific gravity of the brilliant pigment is prevented, and dispersion stability of the brilliant pigment is increased.

The resin layer for flaking in the composite pigment technical product for preparing the brilliant pigment used in the exemplary embodiment is an undercoating layer of the metal or the metal compound layer and is a flaking layer for enhancing a flaking property between the metal or the metal compound layer and the surface of the sheet base material. Although resin used in the resin layer for flaking is not particularly limited, preferable examples thereof include polyvinyl alcohol, polyvinyl butyral, polyethylene glycol, polyacrylic acid, polyacrylamide, a cellulose derivative, acrylic acid copolymer, or modified nylon resin.

The sheet base material is coated with a solution of one kind of the resin or a mixture of two or more kinds of resin and is dried, and the layer is thus formed. The coating solution may contain an additive such as viscosity adjuster.

The resin layer for flaking is applied by a typically used gravure application, roll application, blade application, extrusion application, dipping application, a spin coating method, or the like. After the application and drying, the surface is smoothed by calendar processing as needed.

Although the thickness of the resin layer for flaking is not particularly limited, the thickness is preferably from 0.5 μm to 50 μm, and more preferably from 1 μm to 10 μm. If the thickness is equal to or greater than 0.5 μm, the amount of the resin dispersed is not insufficient. If the thickness is equal to or less than 50 μm, flaking at the interface from the pigment layer tends not to occur in a case of rolling the composite pigment technical product.

Although the sheet base material in the composite pigment technical product for preparing the brilliant pigment used in the exemplary embodiment is not particularly limited, examples thereof include a polyolefin film of polytetrafluoroethylene, polyethylene, polypropylene, or the like, a polyester film of polyethylene terephthalate, a polyamide film of 66 nylon, 6 nylon, or the like, and a release film such as a polycarbonate film, a triacetate film, or a polyimide film.

A preferable sheet base material is polyethylene terephthalate or copolymer thereof.

Although the thickness of the sheet base material is not particularly limited, and the thickness is preferably from 10 μm to 150 μm. If the thickness is equal to or greater than 10 μm, there is no problem in operatability in processes. If the thickness is equal to or less than 150 μm, satisfactory flexibility is achieved, and there is no problem in rolling, flaking, and the like.

The metal or the metal compound layer may be nipped between protective layers. Examples of the protective layers include silicon oxide layers and protective resin layers.

Although the silicon oxide layer is not particularly limited as long as the layer contains silicon oxide, the silicon oxide layer is preferably formed from silicon alkoxide such as tetraalkoxy silane or polymer thereof by a sol-gel method.

A film coated with a silicon oxide layer is formed by applying an alcohol solution, in which the silicon alkoxide or polymer thereof is dissolved, to the metal or the metal compound layer and heating and firing the alcohol solution.

Resin contained in the protective resin layer is not particularly limited. However, examples thereof include polyvinyl alcohol, polyethylene glycol, polyacrylic acid, polyacrylamide, or a cellulose derivative, and preferable examples include polyvinyl alcohol or a cellulose derivative.

The protective resin layer is formed by applying an aqueous solution of one kind of the resin or a mixture of two or more kinds of the resin to the metal or the metal compound layer and drying the aqueous solution. The applied solution may contain an additive such as a viscosity adjustor.

The silicon oxide and the resin are applied by the same method as that for the application of the resin layer for flaking.

Although the thickness of the protective layer is not particularly limited, the thickness is preferably within a range from 50 nm to 150 nm. If the thickness is equal to or greater than 50 nm, sufficient mechanical strength of the protective layer is obtained. If the thickness is equal to or less than 150 nm, the strength of the protective layer does not become excessively higher, and it does not become difficult to pulverize and disperse the metal or the metal compound layer. In addition, flaking at the interface between the protective layer and the metal or the metal compound layer tends not to occur.

A coloring material layer may be provide between the “protective layer” and “the metal or the metal compound layer”.

The color material layer is introduced to obtain an arbitrary composite coloring pigment and is not particularly limited as long as the coloring material layer may contain a coloring material that may apply an arbitrary color tone and a color hue in addition to metallic luster and brilliance of the brilliant pigment used in the exemplary embodiment. As the coloring material used in the coloring material layer, any of dye and a pigment may be used. In addition, a known dye or a known pigment may be used as the dye or the pigment.

In this case, the “pigment” used in the coloring material layer means a natural pigment, a synthesized organic pigment, a synthesized inorganic pigment, or the like typically defined in the field of pigment chemistry, and is different from a pigment processed to have a laminated structure, such as the “composite pigment” in the exemplary embodiment.

Although the method of forming the coloring material layer is not particularly limited, the coloring material layer is preferably formed by coating.

In a case here the coloring material used in the coloring material layer is a pigment, it is preferable that a resin for dispersing the coloring material is further contained, and polyvinyl butyral, an acrylic acid copolymer, or the like is preferably used as the resin for dispersing the coloring material. In such a case, the coloring material layer is preferably prepared as a resin thin film by dispersing or dissolving the pigment, the resin for dispersing the coloring material, and if necessary, other additives in a solvent to obtain a solution, forming a liquid film on the metal or the metal compound layer by spin coating as a solution, and then drying the liquid film.

In preparing the composite pigment technical product for preparing the brilliant pigment used in the exemplary embodiment, it is preferable that both the coloring material layer and the protective layer are formed by coating, in terms of operation efficiency.

The composite pigment technical product for preparing the brilliant pigment used in the exemplary embodiment may have a layered structure including multiple structures in which the resin layer for flaking and the metal or the metal compound layer are laminated in order. At this time, the thickness of the entire multiple layered structures in which metal or the metal compound layer are laminated, that is, the thickness of the metal or the metal compound layer—the resin layer for flaking—the metal or the metal compound layer, . . . , the resin layer for flaking—the metal or the metal compound layer except for the sheet base material and the resin layer for flaking immediately above the sheet base material is preferably equal to or less than 5,000 nm. If the thickness is equal to or less than 5,000 nm, cracking and flaking tend not to occur, and excellent storage stability is achieved even in a case of rounding the composite pigment technical product into a rolled shape. Even in a case of forming a pigment, excellent brilliance is achieved, which is preferable.

Although a structure in which the resin layer for flaking and the metal or the metal compound layer are laminated in order on both surfaces of the sheet base material is also exemplified, the structure is not limited thereto.

The brilliant pigment used in the exemplary embodiment may be obtained by flaking the metal or the metal compound layer in the composite pigment technical product from the sheet base material at the interface corresponding to the resin layer for flaking, and pulverizing and refining the metal or the metal compound layer.

Although the flaking processing method is not particularly limited, a method of dipping the composite pigment technical product in a liquid or a method of dipping the composite pigment technical product in the liquid, performing ultrasonic processing, flaking processing, and pulverization processing of the composite pigment flaked is preferably performed.

According to the brilliant pigment obtained as described above, the resin layer for flaking serves as a protective colloid, and a stable dispersion is easily obtained merely by performing dispersion processing in a solvent.

The method of measuring the water surface diffusion area, which is defined by JIS K5906:2009; of the brilliant pigment used in the exemplary embodiment will be described in detail as follows.

The brilliant pigment is extracted from the brilliant toner by the following method. Thereafter, the extracted sample is washed with a petroleum spirit or acetone, is dried, and is pulverized into particles. The water surface diffusion area may be obtained by sprinkling the particles on a water surface of a water surface diffusion area measuring apparatus and obtaining an area in which the water surface is uniformly covered with aluminum particles.

A method of extracting the brilliant pigment from the brilliant toner is not particularly limited, and the brilliant pigment may be separately collected by putting the brilliant toner into a solvent (such as tetrahydrofuran) in which a binder resin is dissolved, dissolving the binder resin, and precipitating the brilliant pigment by centrifugal processing. In a case where an external additive is added to the brilliant toner, the external additive may be removed from the toner by ultrasonic processing as pre-processing before putting the brilliant toner into the solvent.

The average longitudinal length of the brilliant pigment is a value measured by the following method.

Surface directions of the brilliant pigment contained in the brilliant toner are aligned along a surface direction of a recording medium by fixing the brilliant toner to the recording medium such as paper and forming a brilliant toner image. The brilliant toner image is embedded by using bisphenol A-type liquid epoxy resin and a curing agent, a sample to be cut is prepared. Then, the sample is cut into pieces at −100° C. by using a cutting machine using a diamond knife, such as an UltracutUCT (manufactured by Leica), and a cut surface of the brilliant toner image is obtained. The cut surface of the brilliant toner image is observed by a transmission electron microscope (TEM), and longitudinal lengths of 100 brilliant pigments are obtained. The observation is performed by setting a magnification to a magnification at which 1 to 10 brilliant pigments may be viewed in a single field of view. An arithmetic mean longitudinal length of the brilliant pigments is calculated from the obtained values, and is regarded as an average longitudinal length.

The longitudinal length of the brilliant pigment means a diameter of a circumscribed circle of the section of the brilliant pigment.

The content of the brilliant pigment is preferably from 1 part by weight to 50 parts by weight, and more preferably from 15 parts by weight to 25 parts by weight with respect to 100 parts by weight of the toner particles, for example.

Release agent Examples of the release agent include hydrocarbon wax; natural wax such as carnauba wax, rice wax, or candelilla wax; synthesized, mineral, or petroleum wax such as montan wax; and ester wax such as fatty acid ester or montanic acid ester. The release agent is not limited thereto.

The melting temperature of the release agent is preferably from 50° C. to 110° C., and more preferably from 60° C. to 100° C.

The melting temperature is obtained based on “Melting peak temperature” described in how to obtain a melting temperature in JIS K 7121-1987 “Method of measuring plastic transition temperature” from a DSC curve obtained by a differential scanning calorimetry (DSC).

The content of the release agent is preferably from 1% by weight to 20% by weight, and more preferably from 5% by weight to 15% by weight with respect to the entire toner particles, for example.

### Other Additives

Examples of other additives include known additives such as a coloring agent other than a magnetic material, a charge-controlling agent, inorganic particles, and the brilliant pigment. Such additives are contained in the toner particles as an internal additive.

Examples of the charge-controlling agent include a dye containing a complex of a quaternary ammonium salt compound, a nigrosine compound, aluminum, iron, or chromium and a triphenylmethane pigment.

As the inorganic particles, one kind or two or more kinds of known inorganic particles such as silica particles, titanium oxide particles, alumina particles, cerium oxide particles, or particles obtained by treating the surfaces thereof with a hydrophobizing agent may be used alone or in combination. Among these examples, silica particles with lower refractive index than that of the binder resin are preferably used. In addition, various kinds of surface treatment may be performed on the silica particles, and for example, silica particles whose surfaces are treated with a silane coupling agent, a titanium coupling agent, or silicone oil, for example, are preferably used.

Examples of the coloring agent other than the brilliant pigment include known coloring agents, and selection is made in accordance with a targeted color tone. As other coloring agent, a coloring agent whose surface has been treated may be used as needed, or the coloring agent may be used with a dispersant.

Examples of other coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, du pont oil red, pyrazolone red, lithol red, rhodamine B lake, lake red C, pigment red, rose Bengal, aniline blue, ultramarine blue, calco oil blue, methylene blue chloride, phthalocyanine blue, pigment blue, phthalocyanine green, and malachite green oxalate or various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazol dye.

### Properties of Toner Particles

The toner particles may be toner particles with a single layer structure or may be toner particles with a so-called core shell structure formed of a core (core particle) and a covering layer (shell layer) covering the core.

It is preferable that the toner particles with the core shell structure is formed of a core containing the brilliant pigment and the binder resin, and if necessary, other additives such as a release agent, and a covering layer containing the binder resin.

Average Maximum Thickness C and Average Equivalent Circle Diameter D of Toner Particles

The toner particles have a flake shape, and the average equivalent circle diameter D is preferably longer than the average maximum thickness C. It is more preferable that the ratio (C/D) of the average maximum thickness C and the average equivalent circle diameter D is within the range from 0.001 to 0.700, it is further preferable that the ratio is within the range from 0.100 to 0.600, and it is particularly preferable that the ratio is within the range from 0.300 to 0.450.

If the ratio (C/D) is equal to or greater than 0.001, strength of the toner is secured, breakage due to a stress during image formation is prevented, decrease in charge and thus occurring blushing due to exposure of the pigment are prevented. On the other hand, if the ratio is equal to or less than 0.700, excellent brilliance may be achieved.

The average maximum thickness C and the average equivalent circle diameter D are measured by the following method.

The toner particles are placed on a flake surface and are then dispersed without irregularity by applying vibration thereto. The average maximum thickness C and the average equivalent circle diameter D are calculated by using a color laser microscope “VK-9700” (manufactured by Keyence Corporation) to magnify 1,000 toner particles 1,000 times, measuring the maximum thickness C of the brilliant toner particles and the equivalent circle diameter D of the plane when viewed from the upper side, and obtaining arithmetic mean values thereof.

Angle Between Longitudinal Axis Direction in Section of Toner Particle and Longitudinal Axis Direction of Brilliant Pigment

In a case of observing a section of a toner particle in the thickness direction, a rate (number basis) of the brilliant pigment with an angle in the range from −30° to +300 between the longitudinal axis direction in the section of the toner particle and the longitudinal axis direction of the brilliant pigment is preferably equal to or greater than 60% with respect to the entire brilliant pigment observed. Furthermore, the rate is further preferably from 70% to 95%, and particularly preferably from 80% to 90%.

If the rate is equal to or greater than 60%, more excellent brilliance may be achieved.

Here, description will be given of a method of observing the section of the toner particle.

The toner particles are embedded by using bisphenol A-type liquid epoxy resin and a curing agent, and a sample to be cut is then created. Next, a cutting machine using a diamond knife, such as an ultramicrotome apparatus (UltracutUCT manufactured by Leica), is used to cut the sample to be cut at −100°, and a sample to be observed is created. The sample to be observed is observed at such a magnification that about 1 to ten toner particles may be viewed in a single field of view by using an ultra-high resolution field emission-type scanning electron microscope (S-4800 manufactured by Hitachi High-Technologies Corporation), for example.

Specifically, the section (the section of the toner particle in the thickness direction) of the toner particle is observed, the number of pieces of the brilliant pigment with an angle in the range from −30° to +300 between the longitudinal axis direction in the section of the toner particle and the longitudinal axis direction of the brilliant pigment among the 100 toner particles observed is counted by using image analysis software such as image analysis software (WinROOF) manufactured by Mitani Corporation, for example, or a printed sample of the observed image and a protractor, and the rate thereof is calculated.

The “longitudinal axis direction in the section of the toner particle” represents a direction orthogonal to the thickness direction of the toner particle with a longer average equivalent circle diameter D than the average maximum thickness C, and the “longitudinal axis direction of the brilliant pigment” represents a length direction of the brilliant pigment.

The volume average particle diameter of the toner particles is preferably from 3 μm to 30 μm, and more preferably from 5 μm to 20 μm.

The volume average particle diameter D₅₀ᵥ of the toner particles is obtained by depicting a cumulative distribution of the volume and the number from the smaller diameter side, respectively, in divided particle diameter ranges (channels) based on particle diameter distribution measured by a measurement apparatus such as MULTISIZER II (manufactured by Beckman Coulter, Inc.). The particle diameter corresponding to accumulation of 16% is defined to have a volume D₁₆ᵥ and a number D₁₆ₚ, a particle diameter corresponding to accumulation of 50% is defined to have a volume D₅₀ᵥ and a number D₅₀ₚ, and a particle diameter corresponding to accumulation of 84% is defined to have a volume D₈₄ᵥ and a number D₈₄ₚ. The volume particle diameter distribution index (GSDv) is calculated as (D₈₄ᵥ/D₁₆ᵥ)^{1/2} by using the values.

A ratio (aspect ratio) of an average length in the longitudinal axis direction on the assumption that the average length of the toner particles in the thickness direction is 1 is preferably from 1.5 to 15, more preferably from 2 to 10, and further preferably from 3 to 8.

The average length in the thickness direction and the average length in the longitudinal axis direction of the toner particles are calculated by placing the toner particles on a smooth surface, dispersing the toner particles with no unevenness by applying vibration, measuring the maximum thicknesses of the brilliant toner particles and lengths in the longitudinal axis direction of surfaces viewed from the upper side while enlarging 1,000 toner particles at a magnification of 1,000 folds by a color laser microscope “VK-9700” (manufactured by Keyence Corporation), and obtaining arithmetic mean values thereof.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

It is preferable that the surfaces of the inorganic particles as the external additive is treated with a hydrophobizing agent. The treatment with the hydrophobizing agent is performed by dipping the inorganic particles in a hydrophobizing agent, for example. Although the hydrophobizing agent is not particularly limited, examples thereof include a silane coupling agent, silicone oil, a titanate coupling agent, and an aluminum coupling agent. One kind or two or more kinds of the hydrophobizing agents may be used alone or in combination.

The amount of the hydrophobizing agent is typically from 1 part by weight to 10 parts by weight with respect to 100 parts by weight of the inorganic particles, for example.

Examples of the external additive also include resin particles (resin particles of polystyrene, polymethyl methacrylate (PMMA), melamine resin, or the like) and a cleaning aid (metal salt of higher fatty acid, representative examples of which include zinc stearate, and particles of fluorine high-molecular-weight material).

The amount of the external additive is preferably from 0.01% by weight to 5% by weight, and more preferably from 0.01% by weight to 2.0% by weight with respect to the amount of the toner particles, for example.

### Preparing Method of Toner

Next, description will be given of a preparing method of the toner according to the exemplary embodiment.

The toner according to the exemplary embodiment is obtained by preparing the toner particles containing the brilliant pigment and then externally adding the external additive to the toner particles.

The toner particles may be prepared by any of a dry manufacturing method (such as a kneading and pulverizing method) and a wet manufacturing method (such as an aggregating and coalescing method, a suspension polymerization method, or a dissolution suspension method). The preparing method of the toner particles is not limited to these manufacturing methods, and a known manufacturing method is employed.

For example, the dissolution suspension method is a method of preparing and obtaining the toner particles by removing an organic solvent after dispersing, in a water solvent containing a particle dispersant, a solution obtained by dissolving or dispersing raw materials that form the toner particles (such as the resin particles and the brilliant pigment) in the organic solvent in which the binder resin may be dissolved.

In addition, the aggregating and coalescing method is a method of obtaining the toner particles by performing an aggregating process for forming an aggregate of the raw materials that form the toner particles (the resin particles, the brilliant pigment, and the like) and a coalescing process of coalescing the aggregate.

It is preferable that the toner particle containing the urea-modified polyester resin as the binder resin is obtained by the dissolution suspension method described below, from among these manufacturing methods. Although a method of obtaining toner particles containing a release agent will be described in the following description of the dissolution suspension method, the release agent is contained in the toner particles as needed. Although a method of obtaining toner particles containing unmodified polyester resin and urea-modified polyester resin as a binder resin will be described, the toner particles may contain only the urea-modified polyester resin as the binder resin.

### Process for Preparing Oil Phase Solution

An oil phase solution is prepared in which materials of toner particles including unmodified polyester resin, polyester prepolymer having isocyanate groups, an amine compound, brilliant pigment, and a release agent are dissolved or dispersed in an organic solvent (process for preparing oil phase solution). The process for preparing an oil phase solution is a process for obtaining a mixture solution of the toner materials by dissolving or dispersing the toner particle materials in the organic solvent.

Examples of methods of preparing the oil phase solution include 1) a method of preparing the oil phase solution by collectively dissolving or dispersing the toner materials in the organic solvent, 2) a method of preparing the oil phase solution by kneading the toner materials in advance and then dissolving or dispersing the kneaded materials in the organic solvent, 3) a method of preparing the oil phase solution by dissolving the unmodified polyester resin, the polyester prepolymer having isocyanate groups, and the amine compound in the organic solvent and then dispersing the brilliant pigment and the release agent in the organic solvent, 4) a method of preparing the oil phase solution by dispersing the brilliant pigment and the release agent in the organic solvent and then dissolving the unmodified polyester resin, the polyester prepolymer having isocyanate groups, and the amine compound in the organic solvent, 5) a method of preparing the oil phase solution by dissolving or dispersing toner particle materials (the unmodified polyester resin, the brilliant pigment, and the release agent) other than the polyester prepolymer having isocyanate groups and the amine compound in the organic solvent and then dissolving the polyester prepolymer having isocyanate groups and the amine compound in the organic solvent, and 6) a method of preparing the oil phase solution by dissolving or dispersing toner particle materials (the unmodified polyester resin, the brilliant pigment, and the release agent) other than the polyester prepolymer having isocyanate groups or the amine compound and then dissolving the polyester prepolymer having isocyanate groups or the amine compound in the organic solvent. The method of preparing the oil phase solution is not limited thereto.

Examples of the organic solvent for the oil phase solution include: an ester solvent such as methyl acetate or ethyl acetate; a ketone solvent such as methyl ethyl ketone or methyl isopropyl ketone; an aliphatic hydrocarbon solvent such as hexane or cyclohexane; and a halogenated hydrocarbon solvent such dichloromethane, chloroform, or trichloroethylene. Such an organic solvent preferably dissolves the binder resin, is preferably dissolved in water at a rate from 0% by weight to 30% by weight, and preferably has a boiling temperature of equal to or less than 100° C. Ethyl acetate is preferably used from among these organic solvents.

### Process for Preparing Suspension

Next, a suspension is prepared by dispersing the obtained oil phase solution in a water phase solution (process for preparing a suspension).

Then, a reaction is caused between the polyester prepolymer having isocyanate groups and the amine compound along with preparation of the suspension. Then, the urea-modified polyester resin is formed by the reaction. The reaction is accompanied with at least one of a crosslinking reaction and an elongation reaction of a molecular chain. The reaction between the polyester prepolymer having isocyanate groups and the amine compound may be performed with a process for removing a solvent which will be described later.

Here, reaction conditions are selected depending on reactivity between an isocyanate group structure of the polyester prepolymer and the amine compound. In one example, reaction time is preferably from 10 minutes to 40 hours, and preferably from 2 hours to 24 hours. A reaction temperature is preferably from 0° C. to 150° C., and preferably from 40° C. to 98° C. For forming the urea-modified polyester resin, a known catalyst (dibutyltin laurate, dioctyltin laurate, or the like) may be used as needed. That is, a catalyst may be added to the oil phase solution or the suspension.

Examples of the water phase solution include a water phase solution obtained by dispersing a particle dispersant such as a resin particle dispersant or an inorganic particle dispersant in an aqueous solvent. Examples of the water phase solution also include a water phase solution obtained by dispersing a particle dispersant in an aqueous solution and dissolving a polymeric dispersant. In addition, a known additive such as a surfactant may be added to the water phase solution.

Examples of the aqueous solution include water (typically, ion exchanged water, distilled water, or pure water, for example). The aqueous solution may be a solvent containing an organic solvent such as alcohol (such as methanol, isopropyl alcohol, or ethylene glycol), dimethylformamide, tetrahydrofuran, cellosolves (such as methyl cellosolve), or lower ketones (such as acetone or methyl ethyl ketone) along with water.

Examples of the organic particle dispersant include a hydrophilic organic particle dispersant. Examples of the organic particle dispersant include particles of poly (meth) acrylic acid alkyl ester resin (such as polymethyl methacrylate), polystyrene resin, and poly (styreneacrylonitrile) resin.

Examples of the inorganic dispersant include a hydrophilic inorganic particle dispersant. Specific examples of the inorganic particle dispersant include particles of silica, alumina, titania, calcium carbonate, magnesium carbonate, tricalcium phosphate, clay, diatomite, or bentonite, and particles of calcium carbonate is preferably used. One kind or two or more kinds of the inorganic particle dispersant may be used alone or in combination.

The surface of the particle dispersant may be treated with polymer having a carboxyl group.

Examples of the polymer having a carboxyl group include copolymer of at least one kind selected from salts (such as alkaline metal salt, alkaline earth metal salt, ammonium salt, and amine salt) obtained by neutralizing α,β-monoethylenic unsaturated carboxylic acid or a carboxyl group in α,β-monoethylenic unsaturated carboxylic acid with alkaline metal, alkaline earth metal, ammonia, amine, or the like and α,β-monoethylenic unsaturated carboxylic acid ester.

Examples of the polymer having a carboxylic group also include salts (such as alkaline metal salt, alkaline earth metal salt, ammonium salt, and amine salt) obtained by neutralizing a carboxyl group in copolymer of α,β-monoethylenic unsaturated carboxylic acid and α,β-monoethylenic unsaturated carboxylic acid ester with an alkali metal, an alkali earth metal, ammonia, amine or the like. One kind or two or more kids of the polymer having a carboxylic group may be used alone or in combination.

Representative examples of α,β-monoethylenic unsaturated carboxylic acid include α,β-unsaturated monocarboxylic acid (such as acrylic acid, methacrylic acid, or crotonic acid) and α,β-unsaturated dicarboxylic acid (such as maleic acid, fumaric acid, or itaconic acid). Representative examples of α,β-monoethylenic unsaturated carboxylic acid ester include alkyl esters of (meth) acrylic acid, (meth) acrylate having an alkoxy group, (meth) acrylate having a cyclohexyl group, (meth) acrylate having a hydroxyl group, and polyalkylene glycol mono (meth) acrylate.

Examples of the polymeric dispersant include a hydrophilic polymeric dispersant. Specific examples of the polymeric dispersant include a polymeric dispersant (water soluble cellulose ether such as carboxymethyl cellulose or carboxyethyl cellulose) that has a carboxyl group and does not have a hydrophobic group (such as a hydroxypropoxy group or methoxy group).

### Process for Removing Solvent

Next, a toner particle dispersion is obtained by removing the organic solvent from the obtained suspension (process for removing the solvent). The process for removing the solvent is a process of preparing the toner particles by removing the organic solvent contained in liquid droplets of the water phase solution that is dispersed in the suspension. The removal of the organic solvent from the suspension may be performed immediately after the process for preparing the suspension, or may be performed 1 minute or more later than the completion of the process for preparing the suspension.

In the process for removing the solvent, the organic solvent is preferably removed from the suspension by cooling or heating the obtained suspension to a range from 0° C. to 100° C., for example.

As a specific method of removing the organic solvent, the following methods are exemplified.

(1) A method of blowing an air flow to the suspension and forcibly updating a gas phase over the surface of the suspension. In this case, the gas may be blow into the suspension.

(2) A method of decreasing the pressure. In this case, the gas phase over the surface of the suspension may be forcibly updated by filling of the gas, or the gas may be further blown in to the suspension.

The toner particles are obtained by the processes.

Here, toner particles in a dried state after a known cleaning process, a solid-liquid separation process, and a drying process are performed on the toner particles formed in the toner particle dispersion are obtained after the completion of the process for removing the solvent.

In the cleaning process, it is preferable to sufficiently perform replacement cleaning by ion exchanged water in terms of chargeability.

In the solid-liquid separation process, it is preferable to perform suction filtration, pressurizing filtration, or the like in terms of productivity though not particularly limited. In the drying process, it is preferable to perform freeze drying, flash drying, fluidized drying, or vibration-type fluidized drying in terms of productivity though not particularly limited.

The toner according to the exemplary embodiment is manufactured by adding an external additive to the obtained toner particles in the dried state and mixing the toner particles with the external additive, for example.

The mixing is preferably performed by using a V blender, a Henschel mixer, a Loedige mixer, or the like.

Furthermore, coarse particles of the toner may be removed by using a vibration classifier, a wind classifier, or the like as needed.

In the exemplary embodiment, an aggregating and coalescing method by which the shape and the particle diameter of the toner particles may be easily controlled and toner particle structures such as a core shell structure may be controlled in a wide range. Hereinafter, detailed description will be given of a preparing method of the toner particles by the aggregating and coalescing method.

The aggregating and coalescing method according to the exemplary embodiment includes a dispersing process for forming resin particles (emulsified particles) by dispersing raw materials forming the toner particles, an aggregating process for forming an aggregate of the resin particles, and a coalescing process for coalescing the aggregate.

### Dispersing Process

The resin particle dispersion may be manufactured by a typical polymerization method such as an emulsion polymerization method, a suspension polymerization method, or a dispersion polymerization method, or may be manufactured by applying a shear stress to a solution obtained by mixing a water medium with a binder resin by a dispersing machine. At this time, the particles may be formed by heating such that the resin component have low viscosity. In addition, a dispersant may be used for stabilizing the dispersed resin particles. As long as the resin is oil-based and dissolved in a solvent with a relatively low solubility with respect to water, the resin particle dispersion is prepared by dissolving the resin in the solvent, dispersing the particles along with a dispersant and a polymer electrolyte in water, and then evaporating the solvent by heating or depressurization.

Examples of the water medium include: water such as distilled water or ion-exchanged water; and alcohols, and water is preferably used.

Examples of the dispersant used in the emulsification process include: water soluble polymer such as polyvinyl alcohol, methyl cellulose, ethyl cellulose, hydroxyethyl cellulose, carboxymethyl cellulose, sodium polyacrylate, or sodium polymethacrylate; a surfactant such as an anionic surfactant such as sodium dodecylbenzenesulfonate, sodium octadecyl sulfate, sodium oleate, sodium laurate, or potassium stearate, a cationic surfactant such as laurylamine acetate, stearylamine acetate, or lauryltrimethylammonium chloride, amphoionic surfactant such as lauryldimethylamine oxide, or a nonionic surfactant such as polyoxyethylene alkyl ether, polyoxyethylene alkyl phenyl ether, polyoxyethylene alkyl amine; or an inorganic salt such as tricalcium phosphate, aluminum hydroxide, calcium sulfate, calcium carbonate, or barium carbonate.

Examples of the dispersing machine used in preparing the emulsified solution include a homogenizer, a homomixer, a pressure kneader, an extruder, and a media dispersing machine. As for the size of the resin particles, an average particle diameter (volume average particle diameter) is preferably equal to or less than 1.0 μm, preferably within a range from 60 nm to 300 nm, and further preferably within a range from 150 nm to 250 nm. If the average particle diameter is equal to or greater than 60 nm, there is a case in which the resin particles are easily aggregated since the resin particles tend to be unstable in the dispersion. If the average particle diameter is equal to or less than 1.0 μm, there is a case in which particle diameter distribution of the toner becomes narrow.

For preparing the release agent dispersion, a release agent is dispersed along with an ionic surfactant and a polymer electrolyte such as polymeric acid or polymeric base in water, the resulting object is heated at a temperature of equal to or greater than a melting temperature of the release agent, and dispersion processing is performed by using a homogenizer or a pressure ejection-type dispersing machine that applies high shear force. By such processing, the release agent dispersion is obtained. In the dispersion processing, an inorganic compound such as polyaluminum chloride may be added to the dispersion. Examples of a preferable inorganic compound include polyaluminum chloride, aluminum sulfate, highly basic polyaluminum chloride (BAC), polyaluminum hydroxide, and aluminum chloride. Among these examples, polyaluminum chloride, aluminum sulfate, and the like are preferably used.

By the dispersion processing, a release agent dispersion containing release agent particles with a volume average particle diameter of equal to or less than 1 μm is obtained.

The volume average particle diameter of the release agent particles is more preferably from 100 nm to 500 nm.

If the volume average particle diameter is equal to or greater than 100 nm, the release agent component is easily taken into the toner in general, which is affected by properties of the binder resin used. If the volume average particle diameter is equal to or less than 500 nm, a satisfactory dispersing state of the release agent in the toner is achieved.

For preparing the brilliant pigment dispersion, it is possible to use a known dispersing method and to use a typical dispersing unit such as a rotation shear-type homogenizer, a ball mill provided with a medium, a sand mill, a dynomill, or an ultimizer, and there is no limitation. The brilliant pigment is dispersed along with the ionic surfactant and the polymer electrolyte such as polymeric acid or polymeric base in water. The volume average particle diameter of the dispersed brilliant pigment is allowable as long as the size is equal to or less than 20 μm. However, the volume average particle diameter within the range from 3 μm to 16 μm is preferable since the volume average particle diameter does not damage an aggregating property and satisfactory dispersion of the brilliant pigment in the toner may be achieved.

The dispersion of the brilliant pigment covered with the binder resin may be prepared by dispersing or dissolving and mixing the brilliant pigment and the binder resin in the solvent and dispersing the resulting object in water by phase transfer emulsification or shear emulsification.

### Aggregating Process

In the aggregating process, a mixed solution is obtained by mixing the resin particle dispersion, the brilliant pigment dispersion, the release agent dispersion, and the like, the mixed solution is heated at a temperature of equal to or less than a glass transition temperature of the resin particles to cause aggregation, and aggregated particles are formed. The aggregated particles are formed by controlling pH of the mixed solution to be acidic while stirred, in many cases. It becomes possible to set the ratio (C/D) within the preferable range under the stirring conditions. More specifically, it becomes possible to reduce the ratio (C/D) by stirring the mixed solution at a high speed and heating the mixed solution in a stage of forming the aggregated particles, and to increase the ratio (C/D) by stirring the mixed solution at a lower speed at a lower temperature. In addition, pH is preferably within the range from 2 to 7, and it is also effective to use an aggregating agent at this time.

In the aggregating process, the release agent dispersion may be added and mixed at one time along with various dispersions such as the resin particle dispersion, or may be divided and added multiple times.

As the aggregating agent, a surfactant with opposite polarity to that of the surfactant used in the dispersant, an inorganic metal salt, and a divalent or higher metal complex are preferably used. Use of the metal complex is particularly preferable since the amount of surfactant used may be reduced and a charging property is enhanced.

As the inorganic metal salt, aluminum salt and polymer thereof are preferably used in particular. As for the valence of the inorganic metal salt, a divalent inorganic metal salt is more suitable than a monovalent inorganic metal salt, a trivalent inorganic metal salt is more suitable than the divalent inorganic metal salt, and tetravalent inorganic metal salt is more suitable than the trivalent inorganic metal salt, and in a case of the same valence, a polymerization-type inorganic metal salt polymer is more suitable in order to obtain narrower particle diameter distribution.

In the exemplary embodiment, it is preferable to use polymer of tetravalent inorganic metal salt containing aluminum in order to obtain narrow particle diameter distribution.

The toner with a configuration in which surfaces of the core aggregated particles are covered with the resin may be prepared by additionally adding the resin particle dispersion when a desired particle diameter of the aggregated particles is obtained (covering process). The configuration in this case is preferable in terms of chargeability and a developing property since the release agent and the brilliant pigment are not easily exposed to the surface of the toner. In the case of additionally adding the resin particle dispersion, an aggregating agent may be added or pH adjustment may be performed before the additional addition.

### Coalescing Process

In the coalescing process, the aggregated particles are coalesced by stopping advancing of the aggregation by increasing pH of the aggregated particle suspension to a range from 3 to 9 in the stirring conditions in the aggregating process and performing heating at the temperature of equal to or greater than the glass transition temperature of the resin.

In the case of covering the core aggregated particles with the resin, the resin is also coalesced to cover the core aggregated particles. Any heating time is allowable as long as the coalescence may be achieved, and the coalescence may be performed for a period of time from about 0.5 hours to about 10 hours.

The resulting object is cooled after the coalescence, and coalesced particles are obtained. In the process of cooling, crystallization may be promoted by reducing a cooling rate in the vicinity of the glass transition temperature of the resin (within the range of glass transition temperature±10° C.), that is, by performing slow cooling.

A solid-liquid separation process such as filtration, and if necessary, a cleaning process and a drying process are performed on the coalesced particles obtained by the coalescence, and toner particles are thus obtained.

Inorganic oxides and the like, representative examples of which include silica, titania, and aluminum oxide, are added and attached to the obtained toner particles as external additives for the purpose of charge adjustment, application of fluidity, application of a charge exchange property, and the like. A preferable externally adding method and a preferable amount of the external additives added are as described above.

In addition to the inorganic oxides and the like, other components (particles) such as a charge-controlling agent, an organic particles, a lubricant, and an abrasive may be added as external additives.

Although the charge-controlling agent is not particularly limited, colorless or light-color charge-controlling agent is preferably used. Examples thereof include complexes of a quaternary ammonium salt compound, a nigrosine compound, aluminum, or chromium, and a triphenylmethane pigment.

Examples of the organic particles include particles, which are typically used as an external additive added to the toner surfaces, of vinyl resin, polyester resin, or silicone resin. The inorganic particles and the organic particles are used as a fluidity aid, a cleaning aid, and the like.

Examples of the lubricant include fatty acid amide such as ethylenebisstearic acid amide, or oleic acid amide and fatty acid metal salt such as zinc stearate or calcium stearate.

Examples of the abrasive include silica, alumina, and cerium oxide as described above.

### Electrostatic Charge Image Developer

The electrostatic charge image developer according to the exemplary embodiment contains at least the toner according to the exemplary embodiment.

The electrostatic charge image developer according to the exemplary embodiment may be single-component developer that contains only the toner according to the exemplary embodiment or may be a two-component developer in which the toner is mixed with a carrier.

The carrier is not particularly limited, and known carriers are exemplified. Examples of the carrier include a covered carrier in which the surfaces of cores made of magnetic particles are covered with resin; a magnetic particle dispersed-type carrier in which magnetic particles are dispersed and blended in matrix resin; and resin impregnation-type carrier in which resin is impregnated in porous magnetic particles.

The magnetic particle dispersed-type carrier and the resin impregnation-type carrier may be carrier in which constituent particles of the carriers form cores and the surfaces thereof are covered with resin.

Examples of the magnetic particles include: magnetic metal such as iron, nickel, or cobalt; and magnetic oxide such as ferrite and magnetite.

Examples of the resin for covering and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymer, styrene acrylic acid copolymer, or straight silicone resin or modified substances thereof that contain a organosiloxane bond, fluorine resin, polyester, polycarbonate, phenol resin, and epoxy resin. The resin for covering and the matrix resin may contain an additive such as conductive particles.

Examples of the conductive particles include: metal such as gold, silver, or copper; and particles of carbon black, titanium oxide, zinc oxide, tin oxide, barium sulfate, aluminum borate, potassium titanate, or the like.

For covering the surfaces of the cores, a covering method using a solution for forming a covering layer that is obtained by dissolving the resin for covering and various additives (used as needed) in an appropriate solvent is exemplified. The solvent is not particularly limited and may be selected in consideration of the type of the resin used, application aptitudes, and the like. Specific examples of the resin covering method include: a dipping method of dipping the cores in the solution for forming the covering layer; a spray method of spraying the solution for forming the covering layer to the surfaces of the cores; a fluidized bed method of spraying the solution for forming the covering layer in a state in which the cores are made to float by air flow; and a kneader coater method of mixing the cores of the carrier and the solution for forming the covering layer in a kneader coater and then removing a solvent.

A mixing ratio (weight ratio) between the toner and the carrier in the two-component developer is preferably from toner:carrier=1:100 to 30:100, and more preferably from 3:100 to 20:100.

Image forming apparatus/image forming method Description will be given of an image forming apparatus and an image forming method according to the exemplary embodiment.

The image forming apparatus according to the exemplary embodiment includes an image holding member, a charging unit that charges a surface of the image holding member, an electrostatic charge image forming unit that forms an electrostatic charge image on the charged surface of the image holding member, a developing unit that accommodates an electrostatic charge image developer and develops the electrostatic charge image formed on the surface of the image holding member as a toner image by the electrostatic charge image developer, a transfer unit that transfers the toner image formed on the surface of the image holding member to a surface of a recording medium, and a fixing unit that fixes the toner image transferred to the surface of the recording medium.

The electrostatic charge image developer according to the exemplary embodiment is applied as the electrostatic charge image developer.

The image forming apparatus according to the exemplary embodiment performs the image forming method (the image forming method according to the exemplary embodiment) including a charging process of charging the surface of the image holding member, an electrostatic charge image formation process of forming the electrostatic charge image on the charged surface of the image holding member, a developing process of developing the electrostatic charge image formed on the surface of the image holding member as the toner image by the electrostatic charge image developer according to the exemplary embodiment, a transfer process of transferring the toner image formed on the surface of the image holding member to the surface of the recording medium, and a fixing process of fixing the toner image transferred to the surface of the recording medium.

As the image forming apparatus according to the exemplary embodiment, a known image forming apparatus such as: a direct transfer-type apparatus that directly transfers the toner image formed on the surface of the image holding member to the recording medium; an intermediate transfer-type apparatus that primarily transfers the toner image formed on the surface of the image holding member to a surface of an intermediate transfer member and secondarily transfers the toner image transferred to the surface of the intermediate transfer member to the surface of the recording medium; an apparatus provided with a cleaning unit that cleans the surface of the image holding member before the charging and after the transferring of the toner image; or an apparatus provided with an erasing unit that erases the charge by irradiating the surface of the image holding member with erasing light before the charging and after the transferring of the toner image is applied.

In a case of the intermediate transfer-type apparatus, a structure including an intermediate transfer member with a surface to which the toner image is transferred, a primary transfer unit that primarily transfers the toner image formed on the surface of the image holding member to the surface of the intermediate transfer member, and a secondary transfer unit that secondarily transfers the toner image transferred to the surface of the intermediate transfer member to the surface of the recording medium, for example, is applied to the transfer unit.

In the image forming apparatus according to the exemplary embodiment, a portion including the developing unit, for example, may have a cartridge structure (process cartridge) that is detachable from the image forming apparatus. As the process cartridge, a process cartridge that accommodates the electrostatic charge image developer according to the exemplary embodiment and is provided with the developing unit is preferably used.

Hereinafter, description will be given of an example of the image forming apparatus according to the exemplary embodiment. However, the image forming apparatus is not limited thereto. Main components illustrated in the drawings will be described, and descriptions of the other components will be omitted.

FIG. 2 is a configuration diagram schematically illustrating an exemplary embodiment of an image forming apparatus that includes a developing device to which the electrostatic charge image developer according to the exemplary embodiment is applied.

In the drawing, the image forming apparatus according to the exemplary embodiment includes a photosensitive drum 20 as the image holding member that rotates in a predetermined direction. In the periphery of the photosensitive drum 20, a charging device 21 that charges the photosensitive drum 20, an exposure device 22, for example, as the electrostatic charge image forming device that forms an electrostatic charge image Z on the photosensitive drum 20, a developing device 30 that develops the electrostatic charge image Z formed on the photosensitive drum 20 as a visible image, a transfer device 24 that transfers the toner image visualized on the photosensitive drum 20 to a recording sheet 28 as the recording medium, and a cleaning device 25 that cleans toner remaining on the photosensitive drum 20 are disposed in order.

In the exemplary embodiment, the developing device 30 includes a developing housing 31 that accommodates a developer G containing a toner 40 as illustrated in FIG. 2. A developing opening 32 opens in the developing housing 31 so as to face the photosensitive drum 20. A developing roller (developing electrode) 33 as a toner holding member is disposed so as to face the developing opening 32. By applying a predetermined developing bias to the developing roller 33, a developing electric field is formed in a region (developing region) nipped between the photosensitive drum 20 and the developing roller 33. Furthermore, a charge injection roller (injection electrode) 34 as a charge injecting member is provided in the developing housing 31 so as to face the developing roller 33. In particular, the charge injection roller 34 also serves as a toner supply roller for supplying the toner 40 to the developing roller 33 in the exemplary embodiment.

Here, a rotation direction of the charge injection roller 34 may be selected. However, the charge injection roller 34 preferably rotates in the same direction as that of the developing roller 33 at the facing portion with a difference in the peripheral speeds (1.5 times or higher, for example), nip the toner 40 in the region between the charge injection roller 34 and the developing roller 33, and injects the charge while scraping, in consideration of a toner supply property and a charge injection property.

Next, description will be given of operations of the image forming apparatus according to the exemplary embodiment.

If an image creating process is started, the charging device 21 charges the surface of the photosensitive drum 20 first, the exposure device 22 writes the electrostatic charge image Z on the charged photosensitive drum 20, and the developing device 30 develops the electrostatic charge image Z as a toner image that is a visible image. Thereafter, the toner image on the photosensitive drum 20 is transported to the transfer portion, and the transfer device 24 electrostatically transfers the toner image on the photosensitive drum 20 to the recording sheet 28 as the recording medium. The cleaning device 25 cleans the toner remaining on the photosensitive drum 20. Thereafter, the fixing device 36 provided with a fixing member 36A (a fixing belt, a fixing roller, and the like) and a pressurizing member 36B fixes the toner image on the recording sheet 28, and an image is obtained.

### Process Cartridge/Toner Cartridge

Description will be given of the process cartridge according to the exemplary embodiment.

The process cartridge according to the exemplary embodiment is a process cartridge that includes a developing unit accommodating the electrostatic charge image developer according to the exemplary embodiment and develops the electrostatic charge image formed on the surface of the image holding member as a toner image by the electrostatic charge image developer and that is detachable from the image forming apparatus.

The process cartridge according to the exemplary embodiment is not limited to the configuration and may have a configuration that includes a developing device, and if necessary, at least one selected from other units such as an image holding member, a charging unit, an electrostatic charge image forming unit, and a transfer unit.

Although an example of the process cartridge according to the exemplary embodiment will be described below, the process cartridge is not limited thereto. In addition, main components illustrated in the drawings will be described, and descriptions of the other components will be omitted.

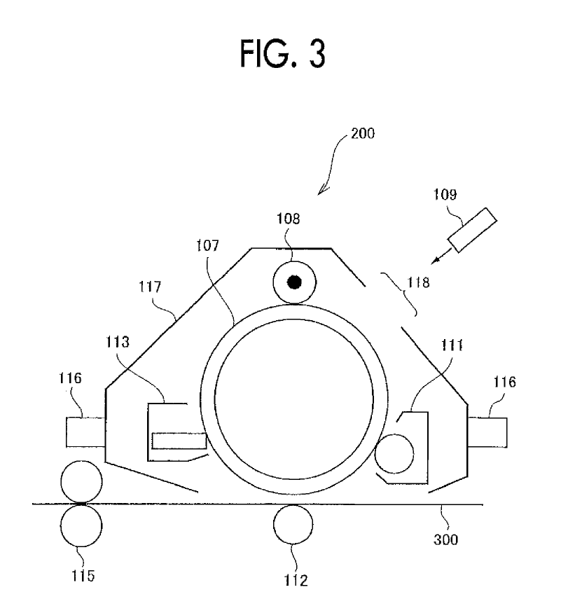

FIG. 3 is a configuration diagram schematically illustrating the process cartridge according to the exemplary embodiment.

The process cartridge 200 illustrated in FIG. 3 integrally combines and holds a photoreceptor 107 (an example of the image holding member), a charging roller 108 (an example of the charging unit) provided in the periphery of the photoreceptor 107, a developing device 111 (an example of the developing unit), and a photoreceptor cleaning device 113 (an example of the cleaning unit) in a housing 117 provided with an attachment rail 116 and an opening 118 for exposure, thus constituting a cartridge.

In FIG. 3, 109 represents an exposure device (an example of the electrostatic charge image forming unit), 112 represents a transfer device (an example of the transfer unit), 115 represents a fixing device (an example of the fixing unit), and 300 represents a recording sheet (an example of the recording medium).

Next, description will be given of a toner cartridge according to the exemplary embodiment.

The toner cartridge according to the exemplary embodiment may accommodate the toner according to the exemplary embodiment and may be detachable from the image forming apparatus. It is only necessary for the toner cartridge according to the exemplary embodiment to accommodate at least the toner, and the developer, for example, may be accommodated therein depending on a mechanism of the image forming apparatus. The toner cartridge according to the exemplary embodiment may have a container which contains the toner according to the exemplary embodiment.

The image forming apparatus illustrated in FIG. 2 is an image forming apparatus with a configuration in which the toner cartridge (not shown) may be freely detachable from, and the developing device 30 is connected to the toner cartridge with a toner supply tube which is not shown in the drawing. In a case in which the amount of toner accommodated in the toner cartridge becomes small, the toner cartridge may be replaced.

### EXAMPLES

Although detailed description will be given below of the exemplary embodiment with reference to examples, the exemplary embodiment is not limited to these examples. In the following description, all the descriptions of “parts” and “%” are on a weight basis unless otherwise indicated.

### Preparation of Unmodified Polyester Resin (1)

Terephthalic acid: 1243 parts
Ethylene oxide adduct of bisphenol A: 1830 parts
Propylene oxide adduct of bisphenol A: 840 parts

The above components are mixed while heated at 180° C., 3 parts of dibutyltin oxide is then added thereto, water is evaporated while the mixture is heated at 220°, and thus, unsaturated polyester resin is obtained. The glass transition temperature Tg of the obtained unsaturated polyester resin is 60° C., the acid value is 3 mgKOH/g, and the hydroxyl group value is 1 mgKOH/g.

### Preparation of Polyester Prepolymer (1)

Terephthalic acid: 1243 parts
Ethylene oxide adduct of bisphenol A: 1830 parts
Propylene oxide adduct of bisphenol A: 840 parts

The above components are mixed while heated at 180° C., 3 parts of dibutyltin oxide is then added thereto, water is evaporated while the mixture is heated at 220° C., and thus, a polyester is obtained. 350 parts of the obtained polyester, 50 parts of tolylene diisocyanate, and 450 parts of ethyl acetate are poured into a container, the mixture thereof is heated at 130° C. for 3 hours, and thus, a polyester prepolymer (1) having isocyanate groups (hereinafter, referred to as isocyanate-modified polyester prepolymer (1)) is obtained.

Preparation of ketimine compound (1) 50 parts of methyl ethyl ketone and 150 parts of hexamethylenediamine are poured into a container, the mixture thereof is stirred at 60° C., and thus, a ketimine compound (1) is obtained.

### Preparation of Brilliant Pigment Dispersion (1)

(A) A uniform liquid film is formed by coating a PET film with a film thickness of 100 m with a resin layer applying solution with the following composition by a spin coating method, the liquid film is then dried, and a resin thin film layer is thus prepared.

### (Resin Layer Applying Solution)

Polyvinyl butyral resin (S-LEC BL-10 manufactured by Sekisui Chemical Co., Ltd.): 3.0%
Glycerin: 2.0%
Isopropyl alcohol (IPA): residual amount

(B) A VE-1010 vacuum deposition apparatus manufactured by Vacuum Device is used to form an aluminum deposited layer with a film thickness of 50 nm is formed on the above resin layer for flaking.

(C) Dispersing processing for flaking and refining the PET film with a laminated structure including the resin layer for flaking and the aluminum deposited layer formed by the methods in IPA by using an ultrasonic cleaner (VS-150) manufactured by As One Corporation is performed for 6.5 hours, and a brilliant pigment dispersion (1) is thus prepared.

The content of the pigment in the brilliant pigment dispersion obtained by the method is 5.0% by weight.

The water surface diffusion area and the average longitudinal length of the brilliant pigment contained in the brilliant pigment dispersion (1) will be shown in Table 1.

### Preparation of Brilliant Pigment Dispersion (2)

A brilliant pigment dispersion (2) is prepared in the same manner as in the preparation of the brilliant pigment dispersion (1) except that the dispersion processing for refinement is performed for 25 hours in (C) of the preparation of the brilliant pigment dispersion (1).

### Preparation of Brilliant Pigment Dispersion (3)

A brilliant pigment dispersion (3) is prepared in the same manner as in the preparation of the brilliant pigment dispersion (1) except that the dispersion processing for refinement is performed for 6 hours in (C) of the preparation of the brilliant pigment dispersion (1).

### Preparation of Brilliant Pigment Dispersion (4)

A brilliant pigment dispersion (4) is prepared in the same manner as in the preparation of the brilliant pigment dispersion (1) except that the dispersion processing for refinement is performed for 2.5 hours in (C) of the preparation of the brilliant pigment dispersion (1).

### Preparation of Brilliant Pigment Dispersion (5)

A brilliant pigment dispersion (5) is prepared in the same manner as in the preparation of the brilliant pigment dispersion (1) except that an aluminum deposited layer with a film thickness of 60 nm is formed in (B) of the preparation of the brilliant pigment dispersion (1).

### Preparation of Brilliant Pigment Dispersion (6)

A brilliant pigment dispersion (6) is prepared in the same manner as in the preparation of the brilliant pigment dispersion (1) except that an aluminum deposited layer with a film thickness of 60 nm is formed in (B) of the preparation of the brilliant pigment dispersion (1) and the dispersion processing for refinement is performed for 25 hours in (C) of the preparation thereof.

### Preparation of Brilliant Pigment Dispersion (7)

A brilliant pigment dispersion (7) is prepared in the same manner as in the preparation of the brilliant pigment dispersion (1) except that an aluminum deposited layer with a film thickness of 60 nm is formed in (B) of the preparation of the brilliant pigment dispersion (1) and the dispersion processing for refinement is performed for 4 hours in (C) of the preparation thereof.

### Preparation of Brilliant Pigment Dispersion (8)

A brilliant pigment dispersion (8) is prepared in the same manner as in the preparation of the brilliant pigment dispersion (1) except that an aluminum deposited layer with a film thickness of 60 nm is formed in (B) of the preparation of the brilliant pigment dispersion (1) and the dispersion processing for refinement is performed for 3 hours in (C) of the preparation thereof.

### Preparation of Brilliant Pigment Dispersion (9)

A brilliant pigment dispersion (9) is prepared in the same manner as in the preparation of the brilliant pigment dispersion (1) except that an aluminum deposited layer with a film thickness of 20 nm is formed in (B) of the preparation of the brilliant pigment dispersion (1).

### Preparation of Brilliant Pigment Dispersion (10)

A brilliant pigment dispersion (10) is prepared in the same manner as in the preparation of the brilliant pigment dispersion (1) except that an aluminum deposited layer with a film thickness of 20 nm is formed in (B) of the preparation of the brilliant pigment dispersion (1) and the dispersion processing for refinement is performed for 25 hours in (C) of the preparation thereof.

### Preparation of Brilliant Pigment Dispersion (11)

A brilliant pigment dispersion (11) is prepared in the same manner as in the preparation of the brilliant pigment dispersion (1) except that an aluminum deposited layer with a film thickness of 20 nm is formed in (B) of the preparation of the brilliant pigment dispersion (1) and the dispersion processing for refinement is performed for 4 hours in (C) of the preparation thereof.

### Preparation of Brilliant Pigment Dispersion (12)

A brilliant pigment dispersion (12) is prepared in the same manner as in the preparation of the brilliant pigment dispersion (1) except that an aluminum deposited layer with a film thickness of 20 nm is formed in (B) of the preparation of the brilliant pigment dispersion (1) and the dispersion processing for refinement is performed for 3 hours in (C) of the preparation thereof.

### Preparation of Brilliant Pigment Dispersion (13)

A brilliant pigment dispersion (13) is prepared in the same manner as in the preparation of the brilliant pigment dispersion (1) except that an aluminum deposited layer with a film thickness of 90 nm is formed in (B) of the preparation of the brilliant pigment dispersion (1).

### Preparation of Brilliant Pigment Dispersion (14)

A brilliant pigment dispersion (14) is prepared in the same manner as in the preparation of the brilliant pigment dispersion (1) except that an aluminum deposited layer with a film thickness of 15 nm is formed in (B) of the preparation of the brilliant pigment dispersion (1).

### Preparation of Brilliant Pigment Dispersion (15)

A brilliant pigment dispersion (15) is prepared in the same manner as in the preparation of the brilliant pigment dispersion (1) except that the dispersion processing for refinement is performed for 63 hours in (C) of the preparation of the brilliant pigment dispersion (1).

### Preparation of Brilliant Pigment Dispersion (16)

A brilliant pigment dispersion (16) is prepared in the same manner as in the preparation of the brilliant pigment dispersion (1) except that the dispersion processing for refinement is performed for 2.0 hours in (C) of the preparation of the brilliant pigment dispersion (1).

### Preparation of Release Agent Dispersion (1)

Paraffin wax (melting temperature: 89° C.): 30 parts
Ethyl acetate: 270 parts

The above components are wet-pulverized by a micro beads disperser (DCP mill) in a state of being cooled at 10° C., and a release agent dispersion (1) is obtained.

### Preparation of Oil Phase Solution (1)

Unmodified polyester resin (1): 136 parts
Brilliant pigment dispersion (1): 500 parts
Ethyl acetate: 56 parts

The above components are stirred and mixed, 75 parts of release agent dispersion (1) is then added to the obtained mixture, the mixture is stirred, and thus, an oil phase solution (1) is obtained.

### Preparation of Styrene Acrylic Resin Particle Dispersion (1)

Styrene: 370 parts
N-butyl acrylate: 30 parts
Acrylic acid: 4 parts
Dodecanethiol: 24 parts
Carbon tetrabromide: 4 parts

A mixture obtained by mixing and dissolving the above components are put into an aqueous solution, which is obtained by dissolving 6 parts of nonionic surfactant (NONIPOL 400 manufactured by Sanyo Chemical Industries, Ltd.) and 10 parts of anionic surfactant (NEOGEN SC manufactured by DSK Co., Ltd.) in 560 parts of ion exchanged water, and are emulsified in a flask, an aqueous solution obtained by dissolving 4 parts of ammonium persulfate in 50 parts of ion exchanged water is poured into the mixture while the mixture is mixed for 10 minutes, the mixture is subjected to nitrogen purge and is then heated in an oil bath until the temperature of the content reaches 70° C. while the content in the flask is stirred, and emulsification polymerization is continued as it is for 5 hours. Thus, a styrene acrylic resin particle dispersion (1) (resin particle concentration: 40%) in which resin particles with an average particle diameter of 180 nm and a weight average molecular weight (Mw) is 15, 500 are dispersed is obtained. The glass transition temperature of the styrene acrylic resin particles is 59° C.

### Preparation of Water Phase Solution (1)

Styrene acrylic resin particle dispersion (1): 60 parts
2% aqueous solution of CELOGEN BS-H (DSK Co., Ltd.): 200 parts
Ion exchanged water: 200 parts

The above components are stirred and mixed, and thus, a water phase solution (1) is obtained.

### Example 1

### Preparation of Toner Particles (1)

Oil phase solution (1): 300 parts
Isocyanate-modified polyester prepolymer (1): 25 parts
Ketimine compound (1): 0.5 parts

The above components are put into a container, an oil phase solution (IP) is obtained by stirring the components for 2 minutes by a homogenizer (ULTRA-TURRAX manufactured by IKA), 1,000 parts of the water phase solution (1) is then added to the container, and the mixture is stirred for 20 minutes by the homogenizer. Then, the mixture solution is stirred at room temperature (25° C.) at an ordinary pressure (1 atm) for 48 hours by a propeller-type stirrer, urea-modified polyester resin is prepared by causing a reaction between the isocyanate-modified polyester prepolymer (1) and the ketimine compound (1), an organic solvent is removed, and grains are obtained. Then, the grains are washed with water, dried, and classified, and thus, the toner particles (1) are obtained. The volume average particle diameter of the toner particles is 7.6 μm, and the aspect ratio is 3.3.

### Preparation of Brilliant Toner (1)

100 parts of toner particles (1), 1.5 parts of hydrophobic silica (RY50 manufactured by Nippon Aerosil Co., Ltd.), and 1.0 parts of hydrophobic titanium oxide (T805 manufactured by Nippon Aerosil Co., Ltd.) are mixed at 10,000 rpm for 30 seconds by a sample mill. Thereafter, the mixture is classified by a vibration classifier with a mesh of 45 μm, and thus, a brilliant toner (1) is obtained.

### Example 2

The oil phase solution (2) is obtained in the same manner as in the preparation of the oil phase solution (1) except that the brilliant pigment dispersion (2) is used instead of the brilliant pigment dispersion (1) in the preparation of the oil phase solution (1).

In addition, the brilliant toner (2) is obtained in the same manner as in the preparation of the brilliant toner (1) except that the oil phase solution (2) is used.

### Example 3

The oil phase solution (3) is obtained in the same manner as in the preparation of the oil phase solution (1) except that the brilliant pigment dispersion (3) is used instead of the brilliant pigment dispersion (1) in the preparation of the oil phase solution (1).

In addition, the brilliant toner (3) is obtained in the same manner as in the preparation of the brilliant toner (1) except that the oil phase solution (3) is used.

### Example 4

The oil phase solution (4) is obtained in the same manner as in the preparation of the oil phase solution (1) except that the brilliant pigment dispersion (4) is used instead of the brilliant pigment dispersion (1) in the preparation of the oil phase solution (1).

In addition, the brilliant toner (4) is obtained in the same manner as in the preparation of the brilliant toner (1) except that the oil phase solution (4) is used.

### Example 5

The oil phase solution (5) is obtained in the same manner as in the preparation of the oil phase solution (1) except that the brilliant pigment dispersion (5) is used instead of the brilliant pigment dispersion (1) in the preparation of the oil phase solution (1).

In addition, the brilliant toner (5) is obtained in the same manner as in the preparation of the brilliant toner (1) except that the oil phase solution (5) is used.

### Example 6

The oil phase solution (6) is obtained in the same manner as in the preparation of the oil phase solution (1) except that the brilliant pigment dispersion (6) is used instead of the brilliant pigment dispersion (1) in the preparation of the oil phase solution (1).

In addition, the brilliant toner (6) is obtained in the same manner as in the preparation of the brilliant toner (1) except that the oil phase solution (6) is used.

### Example 7

The oil phase solution (7) is obtained in the same manner as in the preparation of the oil phase solution (1) except that the brilliant pigment dispersion (7) is used instead of the brilliant pigment dispersion (1) in the preparation of the oil phase solution (1).

In addition, the brilliant toner (7) is obtained in the same manner as in the preparation of the brilliant toner (1) except that the oil phase solution (7) is used.

### Example 8

The oil phase solution (8) is obtained in the same manner as in the preparation of the oil phase solution (1) except that the brilliant pigment dispersion (8) is used instead of the brilliant pigment dispersion (1) in the preparation of the oil phase solution (1).

In addition, the brilliant toner (8) is obtained in the same manner as in the preparation of the brilliant toner (1) except that the oil phase solution (8) is used.

### Example 9

The oil phase solution (9) is obtained in the same manner as in the preparation of the oil phase solution (1) except that the brilliant pigment dispersion (9) is used instead of the brilliant pigment dispersion (1) in the preparation of the oil phase solution (1).

In addition, the brilliant toner (9) is obtained in the same manner as in the preparation of the brilliant toner (1) except that the oil phase solution (9) is used.

### Example 10

The oil phase solution (10) is obtained in the same manner as in the preparation of the oil phase solution (1) except that the brilliant pigment dispersion (10) is used instead of the brilliant pigment dispersion (1) in the preparation of the oil phase solution (1).

In addition, the brilliant toner (10) is obtained in the same manner as in the preparation of the brilliant toner (1) except that the oil phase solution (10) is used.

### Example 11

The oil phase solution (11) is obtained in the same manner as in the preparation of the oil phase solution (1) except that the brilliant pigment dispersion (11) is used instead of the brilliant pigment dispersion (1) in the preparation of the oil phase solution (1).

In addition, the brilliant toner (11) is obtained in the same manner as in the preparation of the brilliant toner (1) except that the oil phase solution (11) is used.

### Example 12

The oil phase solution (12) is obtained in the same manner as in the preparation of the oil phase solution (1) except that the brilliant pigment dispersion (12) is used instead of the brilliant pigment dispersion (1) in the preparation of the oil phase solution (1).

In addition, the brilliant toner (12) is obtained in the same manner as in the preparation of the brilliant toner (1) except that the oil phase solution (12) is used.

### Comparative Example 1

The oil phase solution (13) is obtained in the same manner as in the preparation of the oil phase solution (1) except that the brilliant pigment dispersion (13) is used instead of the brilliant pigment dispersion (1) in the preparation of the oil phase solution (1).

In addition, the brilliant toner (13) is obtained in the same manner as in the preparation of the brilliant toner (1) except that the oil phase solution (13) is used.

### Comparative Example 2

The oil phase solution (14) is obtained in the same manner as in the preparation of the oil phase solution (1) except that the brilliant pigment dispersion (14) is used instead of the brilliant pigment dispersion (1) in the preparation of the oil phase solution (1).

In addition, the brilliant toner (14) is obtained in the same manner as in the preparation of the brilliant toner (1) except that the oil phase solution (14) is used.

### Comparative Example 3

The oil phase solution (15) is obtained in the same manner as in the preparation of the oil phase solution (1) except that the brilliant pigment dispersion (15) is used instead of the brilliant pigment dispersion (1) in the preparation of the oil phase solution (1).

In addition, the brilliant toner (15) is obtained in the same manner as in the preparation of the brilliant toner (1) except that the oil phase solution (15) is used.

### Comparative Example 4

The oil phase solution (16) is obtained in the same manner as in the preparation of the oil phase solution (1) except that the brilliant pigment dispersion (16) is used instead of the brilliant pigment dispersion (1) in the preparation of the oil phase solution (1).

In addition, the brilliant toner (16) is obtained in the same manner as in the preparation of the brilliant toner (1) except that the oil phase solution (16) is used.

### Example 13

### Preparation of Resin Particle Water Dispersion (1)

Terephthalic acid: 30 mol parts
Fumaric acid: 70 mol parts
Ethylene oxide adduct of bisphenol A: 5 mol parts
Propylene oxide adduct of bisphenol A: 95 mol parts

The above materials are prepared in a flask with 5 liter-content, which is provided with a stirrer, a nitrogen introduction tube, a temperature sensor, and a rectifier, the temperature is increased to 220° C. in 1 hour, and 1 part of titanium tetraethoxide is put into 100 parts of the above materials. The temperature is increased to 230° C. in 0.5 hours while generated water is evaporated, dehydration condensation reaction is continued at the temperature for 1 hour, and a reactant is then cooled. As described above, a polyester resin (1) with a weight average molecular weight of 18,000, an acid value of 15 mgKOH/g, and a glass transition temperature of 60° C. is synthesized. The acid value of the resin is measured by a neutralization titration method based on JIS K0070-1992.

40 parts of ethyl acetate and 25 parts of 2-butanol are put into a container provided with a temperature adjuster and a nitrogen replacing unit to obtain a mixed solvent, 100 parts of polyester resin (1) is then slowly poured thereinto and is dissolved therein, 10% ammonia aqueous solution (3 times equivalent amount at a molar ratio with respect to the acid value of the resin) is put thereinto, and the mixture is stirred for 30 minutes.

Then, the content of the container is substituted with dry nitrogen, the temperature is maintained at 40° C., 400 parts of ion-exchanged water is dropped at a speed of 2 parts/minute while the mixture solution is stirred, and emulsification is thus performed. After completion of the dropping, the temperature of the emulsified solution is returned to the room temperature (from 20° to 25° C.), ethyl acetate and 2-butanol are reduced to 1,000 ppm or less by performing bubbling with dry nitrogen for 48 hours while stirring the emulsified solution, and a resin particle water dispersion in which resin particles with a volume average particle diameter of 200 nm are dispersed are thus obtained. Ion-exchanged water is added to the resin particle water dispersion, the solid content is adjusted to 20%, and thus, a resin particle water dispersion (1) is obtained.

### Preparation of Brilliant Pigment Water Dispersion (1)

Brilliant pigment dispersion (1): 100 parts
Anion surfactant (NEOGEN R manufactured by DSK Co., Ltd.): 1.5 parts
Ion-exchanged water: 900 parts

The above materials are mixed dispersed for 1 hour by using an emulsification disperser CAVITRON (CR1010 manufactured by Pacific Machinery & Engineering Co., Ltd.), IPA is reduced to 1,000 ppm or less by performing bubbling with dry nitrogen for 48 hours while stirring the materials, and a brilliant pigment water dispersion (1) (solid content: 10%) with the brilliant pigment (aluminum pigment) dispersed therein is thus prepared.

### Preparation of Release Agent Water Dispersion (1)

Paraffin wax (HNP-9 manufactured by Nippon Seiro Co., Ltd.): 100 parts
Anionic surfactant (NEOGEN RK manufactured by DSK Co., Ltd.): 1 part
Ion-exchanged water: 350 parts

The above materials are mixed, are heated to 100° C., are dispersed by using a homogenizer (ULTRA-TURRAX T50 manufactured by IKA), and are subjected to dispersion processing by using a MANTON GAULIN high-pressure homogenizer (manufactured by Manton Gaulin Manufacturing Co., Inc.), and a release agent water dispersion (1) (solid content: 20%) with release agent particles with a volume average particle diameter of 200 nm dispersed therein is thus obtained.

### Preparation of Toner

Resin particle water dispersion (1): 450 parts
Release agent water dispersion (1): 50 parts
Brilliant pigment water dispersion (1): 21.7 parts
Nonionic surfactant (IGEPAL CA 897): 1.4 parts

The above materials are place in a 2 L cylindrical stainless steel container and are dispersed and mixed for 10 minutes while shear force is applied at 4,000 rpm by a homogenizer (ULTRA-TURRAX T50 manufactured by IKA). Then, 1.75 parts of 10% nitric acid solution of poly aluminum chloride as an aggregating agent is slowly dropped thereto, the mixture is dispersed and mixed for 15 minutes by setting the rotational speed of the homogenizer to 5,000 rpm, and a raw material dispersion is thus obtained.

Thereafter, the aggregated particle dispersion is moved to a polymerization tank provided with a stirrer using two-paddle stirring blades and a thermometer, heating by a mantle heater is started while setting the stirring rotation speed to 550 rpm, and growth of the aggregated particles is promoted at 54° C. At this time, pH of the raw material dispersion is controlled within a range from 2.2 to 3.5 by 0.3 N of nitric acid and 1 N of sodium hydroxide aqueous solution. The raw material dispersion is maintained in the pH range for about 2 hours, and aggregated particles are formed. At this time, the volume average particle size of the aggregated particles measured by using a MULTISIZER II (aperture diameter: 50 μm, manufactured by Beckman Coulter, Inc.) is 10.6 μm.

Next, 100 parts of resin particle water dispersion (1) is additionally added, and resin particles are made to attach to the surfaces of the aggregated particles. The temperature is further increased to 56° C., and aggregated particles are organized while the particle sizes and configurations are observed by an optical microscope and a MULTISIZER II.

Thereafter, pH is increased to 8.0 to coalesce the aggregated particles, and the temperature is then increased to 80° C. at a speed of 0.01° C./minute. After checking that the aggregated particles have been coalesced by the optical microscope, pH is lowered to 6.0 while the temperature is maintained at 80° C., and the heating is stopped 2.5 hours later, and cooling is performed at a temperature lowering speed of 1.0° C./minute. Thereafter, the particles are classified with a mesh of 20 μm, are repeatedly washed with water, and are dried by a vacuum dryer, and thus, brilliant toner particles (1) are obtained.

TABLE 1

| Brilliant | Water surface | Average |
|---|---|---|
| pigment | diffusion area | longitudinal |
| dispersion | (m²/g) | length/μm |
| 1 | 7.4 | 4.2 |
| 2 | 7.5 | 0.8 |
| 3 | 7.3 | 6.3 |
| 4 | 7.4 | 9.7 |
| 5 | 5.3 | 3.8 |
| 6 | 5.1 | 0.6 |
| 7 | 5.2 | 6.1 |
| 8 | 5.2 | 9.5 |
| 9 | 19.1 | 4.0 |
| 10 | 19.6 | 0.9 |
| 11 | 19.8 | 5.9 |
| 12 | 19.7 | 9.8 |
| 13 | 4.7 | 4.3 |
| 14 | 20.4 | 3.9 |
| 15 | 7.2 | 0.3 |
| 16 | 7.7 | 10.4 |

### Measurement/Evaluation

### Measurement of Toluene Insoluble Portion

The toluene insoluble portions (toluene insoluble portions other than the brilliant pigments and the external additives) in the brilliant toners obtained in the respective examples are measured by the method. The results will be shown in Table 2.

### Preparation of Developer

36 parts of each brilliant toners obtained in the respective examples and 414 parts of carrier are put into a 2-liter blender and are stirred for 20 minutes, and 212 μm of the mixture is then classified to prepare each developer. As the carrier, a carrier obtained by the following method is used.

### Preparation of Carrier

Ferrite particles (volume average particle diameter: 35 μm): 100 parts
Toluene: 14 parts
Methyl methacrylate-perfluorooctylethyl acrylate copolymer (critical surface tension: 24 dyn/cm): 1.6 parts
Carbon black (product name: VXC-72 manufactured by Cabot Corporation, volume resistivity: equal to or less than 100 Ωcm): 0.12 parts
Crosslinked melamine resin particles (average particle diameter: 0.3 μm, toluene insoluble): 0.3 parts

First, carbon black is diluted in toluene, the mixture is added to the methyl methacrylate-perfluorooctyl ethyl acrylate copolymer and is dispersed in a sand mill. Then, the above respective components other than the ferrite particles are dispersed for 10 minutes by a stirrer, and a solution for forming a covering layer is obtained. Then, the solution for forming the covering layer and the ferrite particles are put into a vacuum degassing-type kneader, and the mixture is stirred at 60° C. for 30 minutes. Then, the pressure is reduced, toluene is evaporated, a resin covering layer is formed, and thus, a carrier is thus obtained.

### Granularity

A developing machine of “modified color 800 press” manufactured by Fuji Xerox Co., Ltd. is filled with the obtained developer. The developing machine is kept in an environment of 80% RH at 35° C. for 72 hours after the filling with the developer.

The modified machine is used to print toner images including a solid image portion with a brilliant toner applied amount of 3.5 g/m² and a gradation image portion by the brilliant toner on 10,000 OK TOP COAT sheets (basis weight: 127, manufactured by Oji Paper Co., Ltd.) in the environment of 80% RH at 35° C. Granularity in the gradation image portion of the 10,000th toner image is visually observed and evaluated based on the following criteria. The obtained results will be shown in Table 2.

### Criteria

G1: No granularity is recognized.

G2: Granularity is slightly recognized.

G3: Although granularity is recognized, no problem is observed.

G4: Granularity is recognized, and strange feeling is obtained.

G5: Granularity is strongly recognized.

### Ratio (X/Y)

A spectroscopic variable-angle colorimeter GC5000L manufactured by Nippon Denshoku Industries Co., Ltd. is used as a varied-angle photometer to cause incident light with an incident angle −45° with respect to the solid image portion of the 10,000th printed toner image to be incident on the solid image, and reflectance X at a light receiving angle +30° and reflectance Y at a light receiving angle −30° are measured. The reflectance X and the reflectance Y are measured from light within a wavelength range from 400 nm to 700 nm at an interval of 20 nm, and average values of the reflectance at the respective wavelengths are obtained. The ratio (X/Y) is calculated from these measurement results. The results will be shown in Table 2.

As the ratio (X/Y) increases, the glossy feeling increases. As the ratio (X/Y) decreases, dull-hued tone increases, and the glossy feeling decreases.

Table 2 also shows volume average particle diameters and aspect ratios of the toner particles.

TABLE 2

| | | | | Volume average | |
|---|---|---|---|---|---|
| | Granu- | Ratio | Insoluble | particle | Aspect |
| | larity | (X/Y) | potion/% | diameter/μm | ratio |
| Example 1 | G1 | 10 | 6 | 7.6 | 3.3 |
| Example 2 | G2 | 8 | 7 | 6.6 | 2.2 |
| Example 3 | G1 | 19 | 5 | 8.2 | 4.0 |
| Example 4 | G2 | 25 | 7 | 8.6 | 5.1 |
| Example 5 | G2 | 9 | 8 | 9.2 | 2.9 |
| Example 6 | G3 | 5 | 6 | 9.0 | 2.1 |
| Example 7 | G2 | 15 | 6 | 9.3 | 3.6 |
| Example 8 | G3 | 20 | 7 | 9.5 | 4.5 |
| Example 9 | G2 | 21 | 8 | 4.6 | 5.2 |
| Example 10 | G3 | 13 | 5 | 4.3 | 2.6 |
| Example 11 | G2 | 26 | 7 | 4.2 | 6.8 |
| Example 12 | G3 | 34 | 6 | 4.8 | 10.0 |
| Example 13 | G1 | 12 | 2 | 7.5 | 2.7 |
| Comparative | G5 | 8 | 7 | 10.1 | 3.3 |
| Example 1 | | | | | |
| Comparative | G5 | 25 | 6 | 3.1 | 6.2 |
| Example 2 | | | | | |
| Comparative | G4 | 4 | 8 | 6.1 | 2.0 |
| Example 3 | | | | | |
| Comparative | G4 | 20 | 7 | 8.8 | 5.3 |
| Example 4 | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A brilliant toner comprising:
toner particles that contain a binder resin; and
a brilliant pigment, wherein:
a water surface diffusion area, which is measured according to the procedure described by Japanese Industrial Standard JIS K5906:2009, of the brilliant pigment is from 5 m²/g to 20 m²/g,
a volume average particle diameter of the toner particles is from 7.5 μm to 8.2 μm, and
an average longitudinal length of the brilliant pigment is from 0.5 μm to 10 μm.

2. The brilliant toner according to claim 1,
wherein an average longitudinal length of the brilliant pigment is equal to or greater than 0.5 μm and less than 5 μm.

3. The brilliant toner according to claim 1,
wherein the brilliant pigment is a metal pigment.

4. The brilliant toner according to claim 3,
wherein the metal pigment is an aluminum pigment.

5. (canceled)

6. The brilliant toner according to claim 1,
wherein an aspect ratio of the toner particles is from 1.5 to 15.

7. The brilliant toner according to claim 1,
wherein a ratio (Lp/Dt) between an average longitudinal length (Lp) of the brilliant pigment and a volume average particle diameter (Dt) of the brilliant toner is from 0.017 to 1.000.

8. The brilliant toner according to claim 1,
wherein a toluene insoluble portion other than inorganic matters in the toner is from 0.1% by weight to 50% by weight with respect to the entire toner.

9. The brilliant toner according to claim 1,
wherein a ratio (C/D) between an average maximum thickness C and an average equivalent circle diameter D of the toner is from 0.001 to 0.700.

10. The brilliant toner according to claim 1,
wherein the binder resin contains an urea-modified polyester resin.

11. An electrostatic charge image developer comprising:
the brilliant toner according to claim 1.

12. A toner cartridge comprising:
a container that contains the brilliant toner according to claim 1,
wherein the toner cartridge is detachable from an image forming apparatus.
